(19) United States
(12) Patent Application Publication
(10) Pub. No.: US 2022/0293948 A1
(43) Pub. Date: Sep. 15, 2022

(54) A NONAQUEOUS ELECTROLYTE SECONDARY BATTERY AND A METHOD FOR MANUFACTURING THE NONAQUEOUS ELECTROLYTE SECONDARY BATTERY

(71) Applicants: ATTACCATO Limited Liability Company, Izumi-shi, Osaka (JP); THE JAPAN STEEL WORKS, LTD., Shinagawa-ku, Tokyo (JP)

(72) Inventors: Takashi MUKAI, Osaka (JP); Yuta IKEUCHI, Osaka (JP); Taichi SAKAMOTO, Osaka (JP); Naoto YAMASHITA, Osaka (JP); Ryou ISHIGURO, Tokyo (JP); Satoru NAKAMURA, Tokyo (JP)

(21) Appl. No.: 17/770,572

(22) PCT Filed: Oct. 30, 2018
(86) PCT No.: PCT/JP2018/040395

§ 371 Date: Apr. 20, 2022

(51) Int. Cl. H01M 4/62; H01M 10/058; H01M 4/38; H01M 4/04; H01M 10/0525

(52) U.S. Cl. CPC H01M 4/622; H01M 10/058; H01M 4/381; H01M 4/0404; H01M 10/0525; H01M 2004/028

(57) ABSTRACT

Characteristics of a battery are improved. The nonaqueous electrolyte secondary battery of the present application includes a positive electrode, a negative electrode, a separator disposed between the positive electrode and the negative electrode, and an electrolyte solution. The positive electrode has a positive electrode active material and a binder for positive electrode. Then, the positive electrode active material has at least an alkali metal element as a constituent element, and the binder for positive electrode has cellulose and a solvent, and carbon dioxide gas is dissolved in the solvent. Further, a part or all of the surface of the positive electrode active material is coated with the cellulose, and a carbonate compound of the alkali metal element is coated on a part or all of the surface of the cellulose. According to such a configuration, it is possible to improve the characteristics of the battery, such as suppression of decrease in carbonic acid concentration due to carbonic acid vaporization, suppression of decrease in battery characteristics, suppression of oxidative decomposition of cellulose fibers, suppression of swelling of active material layer, and active decomposition of alkali metal carbonate.

### TECHNICAL FIELD OF THE INVENTION

The present invention relates to a nonaqueous electrolyte secondary battery and a method of manufacturing the nonaqueous electrolyte secondary battery, and more particularly, to a binder for electrode used in a nonaqueous electrolyte secondary battery.

### BACKGROUND OF THE INVENTION

The field of use of secondary batteries is expanding from electronic equipment to automobiles and large-scale power storage systems, and the market size is expected to grow to over 10 trillion yen industries. In particular, information and communications equipment, such as mobile phones, smartphones, and tablet devices, achieved remarkable penetration, with a global penetration rate exceeding 30%.

In addition, rechargeable batteries are being applied to the power supply of next-generation vehicles, including electric vehicles (EVs), plug-in hybrid vehicles (PHEV), and hybrid vehicles (HEVs). And, the secondary battery has been used for home backup power supply, storage of natural energy, load leveling, etc. in the wake of the Great East Japan Earthquake in 2011, and the application of the secondary battery has been expanding. Thus, it can be said that secondary batteries are also indispensable in introducing energy saving technologies and new energy technologies.

Until now, secondary batteries have mainly been alkaline secondary batteries such as nickel-cadmium (Ni—Cd) batteries and nickel-hydrogen (Ni-MH) batteries, but the use of lithium-ion batteries, which are nonaqueous electrolyte secondary batteries, has been increasing because of their small size, light weight, high-voltage, and no memory effectiveness. The lithium ion battery is composed of a positive electrode, a negative electrode, a separator, an electrolytic solution or an electrolyte, and a battery case.

An electrode such as a positive electrode or a negative electrode is composed of an active material, a conductive auxiliary agent, a binder, and a current collector. Generally, the electrode is manufactured by mixing an active material, a conductive aid, and a binder in a solvent such as an organic solvent or water to form a slurry, coating the slurry on a current collector (mainly aluminum for the positive electrode or copper or nickel in the negative electrode), drying, and then rolling in a roll press or the like.

As a positive electrode active material in lithium ion batteries, mainly lithium cobaltate (LiCoO₂), ternary material (Li(Ni,Co,Mn)O₂), nickel-cobalt-lithium aluminate (Li(Ni,Co,Al)O₂), and the like have been widely used as positive electrode materials for practical batteries. Recently, research and development of positive polar materials such as lithium excess solid solution system material (Li₂MnO₃—LiMO₂) and lithium silicate system material (Li₂MSiO₄) have also been actively carried out.

LiCoO₂ exhibits discharge voltages of 3.7V (vs. Li/Li⁺) or more, and the effective discharge capacity is about 150 mAh/g, and stable cycle-life characteristics are obtained, and therefore, it is mainly used in mobile device applications. However, large-scale batteries such as in-vehicle (EV, PHEV, HEV) and power storage batteries have problems that are largely susceptible to the effect of cobalt (Co) prices. Therefore, a three-way (Li(Ni,Co,Mn)O₂; hereinafter, referred to as NCM) positive electrode with a low Co content and a nickel-cobalt-lithium aluminate (Li(Ni,Co,Al)O₂; hereinafter, referred to as NCA) positive electrode have been adopted.

The NCM can adjust charge/discharge characteristics by changing the molar ratio of three transition metal elements consisting of nickel (Ni), cobalt (Co), and manganese (Mn).

Before 2015, NCM positive electrodes were predominantly made of Ni:Co:Mn=1:1:1 (Li (Ni_{0.33}Co_{0.33}Mn_{0.33})O₂; hereinafter referred to as NCM111)) in molar ratio of transition metals. From 2016 onwards, however, Ni:Co:Mn=5:2:3 (Li (Ni_{0.5}Co_{0.2}Mn_{0.3})O₂; hereinafter referred to as NCM523)) is becoming popular by reducing the amount of Co and increasing the amount of Ni. Recently, research and development of NCM positive poles such as Ni:Co:Mn=6:2:2 material (Li(Ni_{0.6}Co_{0.2}Mn_{0.2})O₂) and Ni:Co:Mn=8:1:1 material (Li(Ni_{0.8}Co_{0.1}Mn_{0.1})O₂)) has become active.

NCA is a positive electrode material in which Co is substituted for Ni sites of lithium nickelate (LiNiO₂) and aluminum (Al) is added to NCA. In general, NCA, the molar ratio of Ni, Co, and Al is 0.65 or more and 0.95 or less for Ni, 0.1 or more and 0.2 or less for Co, and 0.01 or more and 0.20 or less for Al. To make this element ratio of NCA suppresses the migration of Ni-cations, improves the thermal stability and durability compared to LiNiO₂, and provides a higher discharging capacity than LiCoO₂.

These nickel-rich NMC positive and NCA positive poles are expected to have higher capacity and lower cost than LiCoO₂.

As negative electrode active materials in lithium ion batteries, graphite, hard carbon (graphitizable carbon), soft carbon (graphitizable carbon), lithium titanate (Li₄Ti₅O₁₂), and the like have been widely used as negative electrode materials in practical batteries. Recently, these materials are mixed with a silicon (Si) based material or a tin (Sn) based material to increase the capacity of the negative electrode.

Graphite has an effective discharge capacity of 340-360 mAh/g, which is nearly equivalent to a theoretical capacity of 372 mAh/g, and exhibits excellent cycle life characteristics.

Hard carbon and soft carbon are amorphous carbon materials, and the effective discharge capacity is 150 to 250 mAh/g, which is lower than crystalline graphite, but excellent in output characteristics.

The effective electrical capacities of Li₄Ti₅O₁₂ are 160 to 180 mAh/g, and the electrical capacities are lower than those of graphite and amorphic copper materials. However, the potential at the time of charging is about 1.5V away from the potential at which lithium is generated, and there is less risk of precipitation of lithium dendrite.

Si-based materials and Sn-based materials are classified into alloy-based materials, and as effective electrical capacities, Si and Sn show discharge capacities of 3000 to 3600 mAh/g and 700 to 900 mAh/g, respectively.

The reason why an electrode such as a positive electrode or a negative electrode is rolled after drying is to increase a contact area with a conductive auxiliary agent or a current collector by shrinking a volume of an active material layer of an electrode, that is, a coating layer made of an active material, a conductive auxiliary agent, or a binder. As a result, the electron conduction network of the active material layer is strongly constructed and the electron conductivity is improved.

An electrode binder is used for binding an active material and an active material, an active material and a conductive auxiliary agent, an active material and a current collector, a conductive auxiliary agent and a current collector, and the like. The binder can be broadly classified into a “solution type” in which a liquid material is used by dissolving in a solvent, a “dispersion type (emulsion-latex type)” in which a solid content is dispersed in a solvent, and a “reaction type” in which a binder precursor is reacted by heat or light.

In addition, the binder can be divided into an aqueous system and an organic solvent system depending on the solvent species. For example, polyvinylidene fluoride (PVdF), which is a typical plastic fluorine-based resin, is a binder of a dissolved type, and an organic solvent such as N-methyl-2-pyrrolidone (NMP) is used at the time of producing an electrode slurry. Styrene butadiene rubber (SBR) is a dispersion type binder, and is used by dispersing SBR fine particles in water. Polyimide (PI) is a binder of a reaction type, and a PI precursor is dissolved or dispersed in a solvent such as NMP, and heat treatment is performed to obtain a tough PI by advancing a crosslinking reaction while undergoing imidization (dehydration reaction and cyclization reaction)

Although it varies depending on the molecular weight of the binder, the substituent, and the like, the binder of the dissolved type includes polyvinylidene fluoride (PVdF), ethylen-vinyl acetate (EVA), and the like. Further, the dispersion type binder includes styrene butadiene rubber (SBR), polytetrafluoroethylene (PTFE), urethane rubber, polypropylene (PP), polyethylene (PE), polyvinyl acetate (PVAc), nitrocellulose, cellulose nanofibers, and the like. Reaction type binder includes polyimide (PI), polyamide (PA), polyamideimide (PAI), polybenzimidazole (PBI), polybenzoxazole (PBO), and the like.

Further, since an organic solvent-based binder including NMP absorbs an electrolytic solution when exposed to an electrolytic solution at a high temperature and swells, thereby increasing the electrode resistance, it is difficult to use in a high temperature environment. In particular, a thermoplastic fluorine-based resin has a property of increasing the swelling ratio as the temperature increases. For example, according to Patent Document 1, it is described that PVdF is swollen by the electrolytic solution when in a high temperature environment of 50° C. or higher, to increase the electrode resistance with the bonding force is weakened, and it lacks high temperature durability.

The water-based dissolved binder is inferior in oxidation resistance or reduction resistance, and many of them are gradually decomposed by repeated charge and discharge, and a sufficient life characteristic cannot be obtained. It also lacks output characteristics because of its low ionic conductivity. Although the dispersed binder has an advantage that water can be used as a solvent, the dispersion stability is easily impaired by the degree of acid and alkali (pH), the moisture concentration or the environmental temperature, and segregation, aggregation, precipitation, and the like tend to occur during mixing of the electrode slurry. Further, the binder fine particles dispersed in water have a particle size of less than 1 μm, and when moisture is vaporized by drying, particles are fused to each other to form a film. Since this film has no conductivity (electrical conductivity) and ionic conductivity, a slight difference in usage has a great effect on the output characteristics and life characteristics of the battery.

When the solvent species is an aqueous binder and an electrode slurry is produced, when a positive electrode active material composed of an alkali metal element (A), a transition metal element (M), and an oxygen element (0) is added, the slurry becomes alkaline (pH value increases). When the pH value of the slurry becomes 11 or more, since it reacts with the aluminum current collector at the time of coating, there is a problem that a uniform electrode is hardly obtained.

Therefore, a method has been proposed in which a particle surface of a positive electrode active material is coated with carbon, ceramics, or the like. By covering the particle surface of the positive electrode active material with carbon or ceramics or the like, even when an aqueous binder is used, the solvent is reduced to be in direct contact with the active material, and an increase in the pH value of the slurry can be suppressed.

For example, according to Non-Patent Document 1, it is described that, since a polyanionic system such as lithium iron phosphate (LiFePO₄) as a positive electrode active material is carbon-coated on a particle surface, a solvent is reduced from being in direct contact with a positive electrode active material even when an aqueous binder is used, and an increase in pH value can be suppressed. In addition, the cycle-life characteristics of a battery in which an acrylic binder and a PVdF binder are used for the positive electrode are shown at 60° C., and the positive electrode in which a PVdF binder is used for the positive electrode has a gradually decreasing capacity, whereas the positive electrode in which an acrylic binder is used has an excellent high temperature durability.

For example, in Patent Document 2, as a reason for making it difficult for a positive electrode to use an aqueous binder like a negative electrode, (1) lithium of a positive electrode active material is eluted and a positive electrode capacity is lowered by contact and reaction of water with a positive electrode active material, (2) oxidative decomposition of an aqueous binder occurs during charging, and (3) it is difficult to disperse a slurry, and the like, and there is a concern that a decrease in positive electrode capacity and cycle characteristics is a battery characteristic. Thus, according to the patent document 2, Li_{α}M_{β}O_{γ} (in the equation, M is Al, Ti, Cr, Mn, Fe, Co, Ni, Cu, Zr, Nb, Mo, Ag, Ta, W, is one or more kinds of metallic elements selected from the group consisting of Ir, 0≤alpha≤6, 1≤beta≤5, 0≤gamma≤12, it is described that, by using the active material provided on the particle surface, even with the water-based binder, the positive active material capacity of the positive active material is not degraded, during charging, it can be prevented from occurring, it has been shown that the positive voltage for a battery with superior high temperature properties.

For example, other Non-Patent Documents 2 and 3 and other Patent Documents 3 to 12 also disclose techniques relating to various batteries.

### PRIOR ART DOCUMENTS

### Patent Document

[Patent Document 1] Japanese International Patent Application Publication No. 2014/057627
[Patent Document 2] Japanese Patent No. 5999683
[Patent Document 3] Japanese Patent No. 6102837
[Patent Document 4] Japanese Patent Application Laid-Open Publication No. 2013-084521
[Patent Document 5] Japanese Patent Application Laid-Open Publication No. 2016-021332
[Patent Document 6] Japanese Patent Application Laid-Open Publication No. 2015-101694
[Patent Document 7] Japanese Patent Application Laid-Open Publication No. 2002-260663
[Patent Document 8] Japanese Patent No. 6149147
[Patent Document 9] Japanese Patent Application Laid-Open Publication No. 2018-063912
[Patent Document 10] Japanese Patent Application Re-published Publication No. 138192/2017
[Patent Document 11] Japanese Patent Application Re-published Publication No. 2017/138193
[Patent Document 12] Japanese Patent Application Laid-Open Publication No. 2003-197195

### Non-Patent Document

[Non-Patent Document 1] Takashi Mukai et al.: Industrial Materials, Vol. 63, No. 12, pp. 18-23 (2015)
[Non-Patent Document 2] Takashi Mukai et al.: Material Stage, vol. 17, No. 5, pp. 29-33 (2017)
[Non-Patent Document 3] Takashi Mukai et al., “Lithium-ion Secondary Batteries: Approach to Design and Evaluation Methods for High Capacity and Improvement of Properties,” Chapter 4, Section 2, Information Technology Corporation, pp. 210-220 (2017)

### SUMMARY OF THE INVENTION

### Problem to be Solved by the Invention

Incidentally, in an active material containing commercially available lithium (Li), lithium hydroxide (LiOH) may be contained as an impurity. It is conceivable that a starting material used for synthesizing an active material containing Li remains, or that the active material itself produces lithium hydroxide, and the like.

In particular, among the active materials containing Li, positive active materials such as NCMs, NCAs, LiNiO₂, Li₂ MnO₃—LiMO₂, Li₂MSiO₄ have a large content of Li Oxide, exhibits strong alkalinity. Therefore, when a plastic fluorine-based resin-based binder is used in the manufacturing process of the slurry, the slurry may be gelled. In a gelled slurry, electrode production is difficult, and a gas may be generated during charging. This phenomenon applies not only to lithium ion batteries but also to nonaqueous electrolyte secondary batteries such as sodium ion batteries and potassium ion batteries.

For example, Patent Document 3 generally, lithium hydroxide, in the positive electrode mixture slurry manufacturing process, reacts with the binder to rapidly increase the slurry viscosity, also it is described that it may cause gelation of the slurry. Therefore, Patent Document 3 proposes coated nickel-nickel composite oxide particles in which the surface of nickel-based lithium-nickel composite oxide particles is coated with a non-electronic conductive polymer having high elution suppression ability in solution by three-dimensional crosslinking of the polymer and an electronic conductive polymer having both electronic conductivity and ionic conductivity, thereby improving atmospheric stability and not adversely affecting battery characteristics.

Patent Document 4 discloses that a LiFePO₄ and SiO-based lithium-ion secondary battery using PIs for a positive electrode and a negative electrode can be stably charged and discharged even at a high temperature of 120° C.

The reaction type binder is excellent in all of heat resistance, binding property and chemical resistance. Among them, the PI-based binder exhibits high heat resistance and binding property, and can obtain stable life characteristics even in an active material having a large volume change, and has a characteristic that the binder hardly swells even in an electrolytic solution at a high temperature.

As a reinforcing material of the binder, Patent Document 5 discloses an electrode structure for an electric storage device comprising an active material containing Si as a main component, a conductive auxiliary material, a binder, and a current collector, characterized in that cellulose nanofibers are composited with a binder made of a water-soluble polymer.

Although cellulose nanofibers are hydrophilic and in most cases in a state dispersed in water, according to Patent Document 6, cellulose nanofibers dispersed in NMP containing no water in a dispersion medium are shown. By mixing the cellulose dispersion in the resin, high performance of the resin utilizing light weight, high strength, high modulus of elasticity, low coefficient of linear thermal expansion, and high heat resistance of cellulose is expected.

According to Patent Document 7, a positive electrode is described in which a binder such as a positive electrode active material, a cellulose fiber, a conductive agent, and a PVdF is suspended in an appropriate solvent, and the obtained mixture slurry is applied to a base which is a current collector and dried.

Further, according to Patent Document 10 and Patent Document 11, a method of neutralizing an alkali component in a slurry using inorganic carbon dissolved in a solvent of a slurry has been proposed. According to this method, since carbon dioxide gas is used as a neutralizing agent, acid does not remain inside the battery as an impurity, and a nonconductive layer is not formed at the interface between the current collector and the active material layer, so that there is an advantage that conductivity and battery characteristics can be improved.

In addition, in an electrode containing an alkali metal carbonate, when the battery is overcharged, carbon dioxide gas is generated before the electrolytic solution or the positive electrode decomposes. Therefore, the pressure valve mounted on the battery can be operated by increasing the internal pressure of the battery with carbon dioxide gas. The main gas released during this time has been shown to be safe carbon dioxide.

In addition to the binder described above, there are little reported examples in the field of lithium ion batteries, but Patent Documents 8 and 9 and Non-Patent Documents 2 and 3 disclose a technique in which an inorganic binder is used for a secondary battery electrode.

Such a lithium-ion battery, cylindrical, square, various shapes of the battery such as a laminate (pouch) type is widely spread. Then, the relatively small capacity of the battery, the cylindrical type is adopted from the viewpoint of pressure resistance and ease of sealing, the relatively large capacity of the battery, square type is adopted because of ease of handling.

And, if attention is paid to the electrode structure of a lithium ion battery, two types, a laminated type and a wound type, are roughly used. That is, in the laminated type battery, an electrode group in which the positive electrode and the negative electrode are alternately laminated through the separator is housed in the battery case. Many of the laminated or stacked type batteries have a square-shaped battery case. On the other hand, the wound type battery is housed in the battery body (battery case) in a state in which the positive electrode and the negative electrode are wound in a spiral shape while sandwiching the separator. There are cylindrical and square type battery cases of the winding type.

As described above, an electrode using a thermoplastic fluorine-based resin as a binder has poor high temperature durability. On the other hand, as in Patent Documents 1 to 5 and Non-Patent Documents 1 to 3, when an aqueous binder or a PI-based binder is used as an electrode binder, high temperature durability can be improved. However, in active materials containing alkali metal elements (Li, Na, K, etc.), when touched with water and moisture, the electrode capacity is lowered, cycle life characteristics are also poor in some materials. If the particle surface of the active material containing an alkali metal element is coated with carbon, ceramics, or the like to suppress direct contact between water and the active material, an increase in the pH value of the slurry can be suppressed, but when the coating material formed on the particle surface of the active material is peeled off in the step of mixing (kneading) the slurry, the pH value of the slurry increases at once. Further, even if the solvent species is an organic solvent-based binder, in the PI-based binder which causes a dehydration reaction in the heat treatment, moisture generated during the electrode drying comes into contact with an active material containing an alkali metal element.

Further, since the PI-based binder is too excellent in chemical resistance, it is not soluble in almost all organic solvents. Therefore, in the preparation of the electrode slurry, a polyamic acid or the like, which is a PI precursor, is used by dissolving in NMP, and heat-treated at 200° C. or higher, and an imidization reaction (dehydration cyclization reaction) is advanced to obtain PI. Then, after the imidization reaction, undergoes a crosslinking reaction by heat treatment at a higher temperature, PI having high mechanical strength is obtained. From the viewpoint of the electrode life, it is preferable that the heat treatment is performed at a high temperature to the extent that the PI is not carbonized. However, when an active material containing a PI precursor and a strongly alkaline alkali metal element is mixed, the PI precursor is segregated, so that a uniformly dispersed slurry is hardly produced, and it is also difficult to adjust the viscosity of the slurry. Further, the heat treatment of 200° C. or higher, also leads to an increase in power consumption during electrode manufacturing.

Patent Document 5 shows that, as a reinforcing material of an electrode, a cellulose nanofiber is mixed with a binder and composited, so that a mechanical strength capable of withstanding a stress generated during a volume expansion and contraction during a lithium insertion and release reaction can be obtained. By compounding the cellulose nanofibers with the water-soluble binder, the mechanical strength of the electrode is improved, and even if an active material having a drastic volume change is used, it is considered that breakage of the conductive network due to charge and discharge is suppressed.

However, the active material containing Li has little change in volume due to charge and discharge. Therefore, the conductive network is hardly destroyed by the volume change. Further, the mechanical strength of the electrode is not related to the swellability with the electrolyte solution at a high temperature. Therefore, even if the mechanical strength of the binder is improved, the cycle life characteristics at a high temperature are not expected to be improved.

In addition, the water-based binder may not be suitable for an active material containing an alkali metal element which is a material dislike moisture and contact. Since most of the aqueous binders (dissolved, dispersed, and reactive types using water as a solvent) undergo oxidative decomposition at the time of charging, even if the strength of the aqueous binder is improved, the characteristics (durability, cycle life characteristics, output characteristics, etc.) of the electrodes at high temperatures are not greatly improved. In addition, when the water-soluble binder comes into contact with an active material containing a strongly alkaline Li, not only the pH value of the slurry increases but also the salting-out of the binder and the viscosity of the slurry change remarkably.

Patent Document 6 shows cellulose nanofibers dispersed in NMP containing no water in a dispersion medium. However, when only cellulose nanofibers dispersed in NMP are used as a binder, there is a problem that when a slurry to which an active material is added is mixed by a planetary centrifugal mixer or the like, aggregation occurs.

Further, when the solid content of the cellulose nanofibers dispersed in the NMP exceeds 10% by mass, the cellulose nanofibers tend to aggregate, so that the solid content cannot be increased. When cellulose nanofibers having a low solid content are used, the electrode slurry naturally becomes a slurry having a low solid content. When this slurry is applied to a current collector, cellulose nanofibers are aggregated during drying of the electrode, so that a uniform electrode is hardly obtained and a drying time is also prolonged. In addition, since the density of the slurry is low, a practical electrode capacity cannot be obtained unless the slurry coating amount per unit area is increased.

However, when the inventors examined an electrode using cellulose nanofibers as a binder, it was found that, although there were the above-mentioned problems, even under a high temperature environment as high as 80° C., the electrode hardly swells by absorbing an electrolyte solution, and functions as an electrode exhibiting excellent cycle life characteristics at a high temperature. In addition, in only the conventional thermoplastic fluorine-based resin binder, when an alkali metal element hydroxide is added, it changes to black and easily undergoes gelation, but a cellulose nanofiber dispersed in NMP does not confirm a phenomenon of gelation even when an alkali metal element hydroxide is added, and fluidity is not lost. However, as a binder, it has been found that an electrode composed solely of cellulose nanofibers is inferior in output characteristics as compared with an electrode using a thermoplastic fluorine-based resin as a binder other than the above-described problems. That is, it has been shown that many cellulose nanofibers have not heretofore been adapted as binders for electrodes.

On the other hand, Patent Document 7 shows a positive electrode containing a binder such as cellulosic fibers and PVdF. Then, according to this configuration, since the hydrogen bonds between the cellulose fibers are weakened and the cellulose fibers themselves swell when they come into contact with the liquid nonaqueous electrolyte, the liquid nonaqueous electrolyte content in the electrode can be increased. Thus, a high capacity and long life battery is obtained.

However, this does not necessarily lead to an advantage in that the battery is operated in a high temperature environment. It is known that a cellulose fiber or a binder swells with an electrolytic solution as the temperature increases. Therefore, when the battery is operated in a high temperature environment, these swelling rates become too large, and the electronic conductivity of the electrode becomes poor. Normally, the electrode is provided with a press pressure regulating step in order to improve the adhesion between the active material layer and the current collector and to improve the electron conductivity, but when the active material layer swells by the high temperature electrolyte, the electrode approaches the electrode before press pressure regulating and the electron conductivity is deteriorated. In particular, in a thermoplastic fluorine-based resin such as PVdF, it tends to occur remarkably, and in some cases, the resin is eluted into the electrolytic solution.

Electrode resistance, which has a large effect on battery characteristics, roughly consists of a resistance derived from ionic conduction and a resistance derived from electronic conduction. Even if either resistance can be lowered, if the other resistance is increased, the battery characteristics are lowered.

In addition to cellulose fibers, in batteries using cellulose-based materials for the positive electrode, when the batteries are initially charged or left in a high temperature environment for a long time, battery swelling (increase in internal pressure due to gas generation) may occur. In a battery using a cellulose-based material as a positive electrode, although the cause of the battery swelling is not necessarily clear, it is considered that gas is generated by oxidative decomposition at the time of charging. It has been found in Patent Document 12, for example, that by replacing the hydrogen atom of carboxymethylcellulose (CMC) with a halogen atom, decomposition is suppressed and the generation of gas is reduced, because if such swelling of the battery is left unattended, there is a possibility that the deterioration of the battery characteristics or the battery breakage may occur.

Patent Document 8 and Patent Document 9 show that an electrode using an inorganic binder of a silicate type or a phosphate type has less swelling of an active material layer even when it comes into contact with an electrolytic solution of a high temperature. However, since the inorganic binder has a large specific gravity as compared with a conventional binder (resin-based binder), the electrode energy density per weight tends to be low.

In Patent Document 10 and Patent Document 11, in the step of neutralizing the alkali component in the slurry using the inorganic carbon dissolved in the solvent of the slurry, there is shown that the inorganic carbon dissolved in the solvent of the slurry is to be an inorganic carbon generated by dissolving carbon dioxide in the solvent of the slurry. The alkali metal carbonate produced by neutralization decomposes during overcharge and generates carbon dioxide gas. This generated carbon dioxide gas can be used to provide a pressure activated safety mechanism to safely shut down the function of the battery. However, the alkali metal carbonate is hardly decomposed in overcharge in a temperature environment of 60° C. or less.

As described above, Patent Document 10 and Patent Document 11 have focused on a method of preventing corrosion of an aluminum current collector, and have not been studied at all on a description relating to swelling of an active material layer in an electrolytic solution at a high temperature, or a problem that an alkali metal carbonate generated by neutralization occurs in a temperature environment of 60° C. or more.

A method of neutralizing an alkali component in a slurry using inorganic carbon dissolved in a solvent of a binder by applying the techniques of Patent Document 10 and Patent Document 11 is conceivable. However, as a problem possessed by the inorganic carbon dissolved in the solvent of the binder, there is a concentration decrease due to carbonic acid vaporization. In other words, when the amount of dissolved carbon dioxide gas in the solvent of the binder decreases (the carbon dioxide gas evaporates (vaporizes)), the neutralization treatment ability of the alkali component decreases. Dissolved carbon dioxide will continue to decrease continuously in the atmosphere, eventually leaving little carbon dioxide.

Further, the electrode slurry is produced by kneading an active material and a binder, a conductive auxiliary agent, and the like together with a solvent, but the inorganic carbon dissolved in the solvent of the binder becomes bubbles and releases bubbles of the dissolved carbonic acid even by mechanical stimuli such as shearing and impact in the charging and kneading process of the active material and the conductive auxiliary agent. Especially, when a material having a large specific surface area is put in, the amount of evaporation of carbon dioxide gas increases.

As a method of suppressing concentration decrease due to carbonic acid vaporization, a method of holding at a pressure higher than atmospheric pressure, a method of reducing mechanical stimulus in a kneading step as much as possible, and the like can be considered. However, a method of holding at a pressure higher than atmospheric pressure may require a simple container if the amount of dissolved carbon dioxide gas is small, but a container having excellent pressure resistance is required when the amount of dissolved carbon dioxide gas increases. In the method of reducing the mechanical stimulus in the kneading process as much as possible, it is difficult to uniformly mix the slurry. In this way, in a binder in which carbon dioxide gas is dissolved, a technique of suppressing carbon dioxide escape over a long period of time is required.

In addition to the above-described problems, in a binder having high viscosity, there is a problem that carbon dioxide gas is hardly dissolved. Therefore, even if a measure of dissolving or dispersing a solid binder is taken using a material in which carbon dioxide gas is dissolved in advance, there is a problem that carbon dioxide gas is degassed in a step of stirring. Thus, a binder is required in which carbon dioxide gas is easily dissolved and carbon dioxide gas is hardly degassed in a step of stirring.

In addition, in the method of Patent Document 10 and Patent Document 11, the hydroxide of the alkali metal contained in the positive electrode active material is neutralized by carbonic acid, and is coated with a dense alkali metal carbonate on a part or all of the surface of the positive electrode active material. However, since the dense alkali metal carbonate inhibits ion conductivity, it becomes a factor to deteriorate the battery output characteristics. This alkali metal carbonate tends to increase as the amount of carbonic acid contained in the binder or slurry increases. By reducing the amount of carbonic acid contained in the binder or slurry, the thickness of the alkali metal carbonate coated on the positive electrode active material can be reduced, but neutralization may not be sufficiently performed in a positive electrode active material composed of an alkali metal element (A) and a transition metal element (M) and an oxygen element (O). If the neutralization cannot be sufficiently performed, in the aqueous slurry (slurry using water as a solvent), the pH value increases to cause deterioration of the current collector, and in the nonaqueous slurry (slurry using NMP as a solvent), the binder is gelled or insolubilized by an alkali. However, high concentration of carbonic acid is difficult to handle because the concentration decrease due to carbonic acid vaporization is rapid.

Incidentally, even if uniformly dispersed, when left standing, the active material and the conductive auxiliary agent contained in the electrode slurry aggregates or sediments over time. In particular, since the larger the specific gravity of the active material is, the active material sinks to the bottom due to gravity, it tends to be an electrode in which uniformity is lost in the process of electrode preparation. Therefore, an electrode slurry which is hardly aggregated or sedimented even after long-term static storage is required.

As described above, four main problems to be solved by the present invention are mainly listed below. That is, the problem 1 is that, when the battery is operated in a high temperature environment, the active material layer swells and the electronic conductivity of the electrode is deteriorated. The problem 2 is that when a battery using cellulose fiber as a positive electrode is initially charged or left for a long time in a high temperature environment, battery swelling occurs. Problem 3 is that the alkali metal carbonate is hardly decomposed by overcharging. Problem 4 is that in a binder in which carbon dioxide gas is dissolved, a concentration decrease due to carbon dioxide vaporization tends to occur.

It is a maximum object of the present invention to simultaneously solve the above-described problems 1 to 4 That is, a first object of the present invention is to suppress deterioration of battery characteristics without swelling the active material layer even when the battery is operated in a high temperature environment of 60° C. or more. A second object of the present invention is to suppress oxidative decomposition of cellulose fibers in a battery in which cellulose fibers are used for a positive electrode. A third object of the present invention is to actively decompose an alkali metal carbonate by overcharging. A fourth object of the present invention is to provide a binder which is capable of suppressing concentration reduction due to carbon dioxide vaporization in a binder in which carbon dioxide gas is dissolved.

As described above, it can be seen that when only cellulose nanofibers or only carbon dioxide is applied as an electrode binder, there are many problems at present. Accordingly, the present inventors have found that, when research has been conducted to combine cellulose nanofibers and carbon dioxide gas, the above-described problems 1 to 4 can be solved simultaneously, resulting in the present invention. The present invention can solve the conventional problems described above and the problems newly discovered by the inventors.

### Means for Solving the Problems

The nonaqueous electrolyte secondary battery disclosed in this application is a nonaqueous electrolyte secondary battery having a positive electrode, a negative electrode, a separator disposed between the positive electrode and the negative electrode, and an electrolytic solution, wherein the positive electrode has a positive electrode active material and a binder for positive electrode. Then, the positive electrode active material has at least an alkali metal element as a constituent element, and the binder for positive electrode has cellulose and a solvent, and carbon dioxide gas is dissolved in the solvent. Further, a part or all of the surface of the positive electrode active material is coated with the cellulose, and a carbonate compound of the alkali metal element is coated on a part or all of the surface of the cellulose.

The method of manufacturing a nonaqueous electrolyte secondary battery disclosed in the present application includes (a) a step of preparing a positive electrode, a negative electrode, a separator disposed between the positive electrode and the negative electrode, and an electrolyte solution, (b) a step of laminating or stacking the positive electrode, the negative electrode, and the separator and immersing the positive electrode, the negative electrode, and the separator in an electrolyte solution. Then, (c) the step of preparing the positive electrode has (c1) a step of forming a binder for positive electrode having cellulose and a solvent and having carbon dioxide gas dissolved therein, (c2) a step of forming a slurry having a positive electrode active material and a binder for positive electrode, and (c3) a step of forming the positive electrode by applying the slurry to a current collector. Further, the positive electrode active material has at least an alkali metal element as a constituent element, and in the step (b), the cellulose is coated on a part or all of a surface of the positive electrode active material, and a carbonic acid compound of the alkali metal element is coated on a part or all of a surface of the cellulose.

### Effect of the Invention

According to the nonaqueous electrolyte secondary battery disclosed in the present application, it is possible to improve the characteristics of the battery (suppression of decrease in carbonic acid concentration due to carbonic acid vaporization, suppression of decrease in battery characteristics, suppression of oxidative decomposition of cellulose fibers, suppression of swelling of an active material layer, and active decomposition of an alkali metal carbonate). In addition, according to the method of manufacturing a nonaqueous electrolyte secondary battery disclosed in the present application, a battery having good characteristics can be manufactured.

### BRIEF DESCRIPTION OF THE DRAWINGS

FIG. 1 is a graph showing by comparing a battery having an electrode containing a binder material A as an electrode binder (Example 1, Example 2, Reference Example 1) in the embodiment, and a battery having an electrode using only the binder material G as an electrode binder (Comparative Example 1).

FIG. 2 is a graph showing by comparing a battery having an electrode including a binder material B as an electrode binder (Examples 3 to 5, Reference Example 2) in the embodiment, and a battery having an electrode using only the binder material G as an electrode binder (Comparative Example 1).

FIG. 3 is a graph showing by comparing a battery having an electrode including a binder material C as an electrode binder (Examples 6 to 8, Reference Example 3) in the embodiment, and a battery having an electrode using only the binder material G as an electrode binder (Comparative Example 1).

FIG. 4 is a graph showing by comparing a battery (Examples 9 to 11) having an electrode including a binder material D as an electrode binder in the embodiment, and a battery having an electrode using only the binder material G as an electrode binder (Comparative Example 1).

FIG. 5 is a graph showing by comparing a battery (Examples 12 to 14) having an electrode including a binder material E as an electrode binder in the embodiment, and a battery having an electrode using only the binder material G as an electrode binder (Comparative Example 1).

FIG. 6 is a graph showing by comparing a battery having an electrode including a binder material F as an electrode binder (Reference Examples 4 to 6) in the embodiment, and a battery having an electrode using only the binder material G as an electrode binder (Comparative Example 1).

FIG. 7 is a graph showing by comparing a battery having an electrode containing a binder material A as an electrode binder (Example 1, Example 2, Reference Example 1) in the embodiment, and a battery having an electrode using only the binder material G as an electrode binder (Comparative Example 1).

FIG. 8 is a graph showing by comparing a battery having an electrode including a binder material B as an electrode binder (Examples 3 to 5, Reference Example 2) in the embodiment, and a battery having an electrode using only the binder material G as an electrode binder (Comparative Example 1).

FIG. 9 is a graph showing by comparing a battery having an electrode including a binder material C as an electrode binder (Examples 6 to 8, Reference Example 3) in the embodiment, and a battery having an electrode using only the binder material G as an electrode binder (Comparative Example 1).

FIG. 10 is a graph showing by comparing a battery (Examples 9 to 11) having an electrode including a binder material D as an electrode binder in the embodiment, and a battery having an electrode using only the binder material G as an electrode binder (Comparative Example 1).

FIG. 11 is a graph showing by comparing a battery having an electrode including a binder material E as an electrode binder (Example 14) in the embodiment, and a battery having an electrode using only the binder material G as an electrode binder (Comparative Example 1).

FIG. 12 is a graph showing by comparing a battery having an electrode including a binder material F as an electrode binder (Reference Examples 4 to 6) in the embodiment, and a battery having an electrode using only the binder material G as an electrode binder (Comparative Example 1).

FIG. 13 is a graph showing by comparing a battery including an electrode containing a binder material A as an electrode binder (Example 15, Example 16, Reference Example 7) in the embodiment, and a battery including an electrode using only a binder material G as an electrode binder (Comparative Example 2).

FIG. 14 is a graph showing by comparing a battery including an electrode containing a binder material A as an electrode binder (Example 15, Example 16, Reference Example 7) in the embodiment, and a battery including an electrode using only a binder material G as an electrode binder (Comparative Example 2).

FIG. 15 is a diagram showing the results of confirming the gelation resistance (gelation resistance test 1 and 2) of the binder in the examples.

FIG. 16 is a graph showing by comparison a battery having test separators 1 to 4 (Examples 17 to 20), and a battery using an uncoated separator (Comparative Example 3).

FIG. 17 is a graph showing the cycle life characteristics at 60° C. environment of the test battery of Examples 22-24 and Comparative Example 5.

FIG. 18 is a graph showing the cycle life characteristics at 80° C. environment of the test battery of Examples 22-24 and Comparative Example 5.

FIG. 19 is a SEM image showing the positive electrode cross section of Example 22 before and after the charge and discharge test.

FIG. 20 is a SEM image showing the positive electrode cross-section of Example 23 before and after the charge and discharge test.

FIG. 21 is a SEM image showing the negative electrode cross section of Example 22 before and after the charge and discharge test.

FIG. 22 is a SEM image showing the negative electrode cross section of Example 23 before and after the charge and discharge test.

FIG. 23 is a graph showing the high temperature standing test results of the battery examined in the third embodiment.

FIG. 24 is a graph showing the high temperature standing test results of the battery examined in the third embodiment.

FIG. 25 is a graph showing the high temperature standing test results of the battery examined in the third embodiment.

FIG. 26 is a graph showing the discharge capacity of the conventional LIB, the developed LIB and alumina coated LIB according to the third embodiment.

### DESCRIPTION OF THE PREFERRED EMBODIMENTS

### Embodiment 1

The binder for positive electrode of the present embodiment is a binder for positive electrode of a nonaqueous electrolyte secondary battery in which carbon dioxide gas is dissolved in a solvent in which cellulose nanofibers (also referred to as “CeNF”) are dispersed.

The cellulose nanofiber has a fiber diameter of 0.002 μm or more and 1 μm or less, a length of a fiber of 0.5 μm or more and 10 mm or less, and an aspect ratio (fiber length of cellulose nanofiber/fiber diameter of cellulose nanofiber) of 2 or more and 100000 or less.

Carbon dioxide is dissolved in a binder solvent at a concentration of 50 mg/L or more and 9000 mg/L or less.

By using such a binder for positive electrode, a cellulose nanofiber is coated on a part or all of the surface of the positive electrode active material. Further, the alkali metal hydroxide contained in the positive electrode active material is neutralized by carbonic acid.

By this neutralization, an alkali metal carbonate (e.g., lithium carbonate, sodium carbonate, Potassium Carbonate, other alkali metal bicarbonate compounds, and the like) is formed. However, since the cellulose nanofibers are coated on the surface of the positive electrode active material, the alkali metal carbonate precipitates while entraining the cellulose nanofibers. That is, a part or all of the surface of the cellulose nanofiber is coated with an alkali metal carbonate (alkali metal carbonate compound)

When cellulose nanofibers and carbonic acid are contained in the binder for positive electrode, carbon dioxide gas dissolved in the solvent is hardly degassed. The concentration of the cellulose nanofibers can be arbitrarily adjusted in the concentration of the carbon dioxide gas, but is generally 0.01% by mass or more and 20% by mass or less, preferably 0.5% by mass or more and 15% by mass or less, and more preferably 1% by mass or more and 10% by mass or less, based on the total amount of the binder for positive electrode (e.g., the total amount of the liquid medium, the NMP, the cellulose nanofibers, and PVdF in the examples described later)

For example, by adjusting the concentration of cellulose nanofibers, it is possible to control the carbon dioxide emission. In the case of suppressing the degassing of the carbon dioxide gas in the binder for positive electrode, the concentration of the cellulose nanofibers is increased, and in the case where it is not necessary to suppress the escape of the carbon dioxide gas in the binder for positive electrode, the concentration of the cellulose nanofibers may be decreased, and it is preferable to adjust the concentration within the above range. However, if the concentration of the cellulose nanofiber is too low beyond the above range, the degassing of the carbon dioxide gas cannot be sufficiently controlled, and if the concentration is too high beyond the above range, the cellulose nanofibers tend to aggregate.

The binder for positive electrode of the present embodiment can be manufactured, for example, by dissolving carbon dioxide gas in a solvent in which cellulose nanofibers are dispersed, or by adding cellulose nanofibers to a solvent in which carbon dioxide gas is dissolved.

In the positive electrode using the binder for positive electrode of this embodiment, a part or all of the surface of the positive electrode active material is coated with cellulose nanofibers. In addition, a part or all of the surface of the cellulose nanofiber is coated with an alkali metal carbonate.

Thus, by coating the surface of the cellulose nanofibers with an alkali metal carbonate, swelling of the cellulose nanofibers can be suppressed. For example, it is possible to suppress swelling of cellulose nanofibers even in an electrolytic solution at a high temperature. Thus, the battery swelling is less likely to occur even when the battery is operated in a high temperature environment. In this manner, the battery can be stably operated.

Further, as another effect of the positive electrode using the binder for positive electrode of the present embodiment, by coating the surface of the cellulose nanofiber with an alkali metal carbonate, the specific surface area (electrochemical reaction field) of the alkali metal carbonate is increased. Thus, for example, during overcharging of the battery, the alkali metal carbonate decomposes, and the carbon dioxide gas in the binder for positive electrode can be increased.

If the carbon dioxide gas contained in the binder for positive electrode is too small, the above-described neutralization reaction does not sufficiently occur, and a desired amount of an alkali metal carbonate coating the cellulose nanofibers cannot be obtained. In addition, when too much carbon dioxide gas is contained in the binder for positive electrode, a neutralization reaction is completed before the surface of the positive electrode active material is coated with cellulose nanofibers, and the cellulose nanofibers cannot be coated with an alkali metal carbonate.

For this reason, the carbon dioxide gas is preferably dissolved in a concentration of 50 mg/L or more and 9000 mg/L or less with respect to the binder solvent, more preferably dissolved at a concentration of 100 mg/L or more and 5000 mg/L or less, and still more preferably dissolved at a concentration of 300 mg/L or more and 2000 mg/L or less. Within such a concentration range of carbon dioxide gas, the surface of the positive electrode active material is coated with cellulose nanofibers, and further, the cellulose nanofibers can be coated with an alkali metal carbonate. In other words, the surface of the positive electrode active material can be covered by cellulose nanofibers coated with an alkali metal carbonate.

As a solvent of the binder for positive electrode, any liquid capable of dissolving carbonic acid may be used, and as a liquid capable of dissolving carbonic acid, for example, water is well-known, but an organic solvent such as NMP may be used.

As a method for dissolving carbon dioxide gas in a binder for positive electrode (a solvent and a binder solvent), a known method for manufacturing carbon dioxide water may be used, and is not particularly limited. For example, there may be a pressure dissolution method, or a chemical method, a method using a static mixer, a method using a hollow fiber membrane, a method of refining and dissolving bubbles of carbon dioxide gas, and the like.

In order to easily dissolve carbon dioxide gas in the above-described concentration range in the binder solvent, a pressure dissolution method is preferably used. Specifically, a solution containing cellulose nanofibers in a suitable ratio is placed in a sealed container, and then a high pressure carbon dioxide gas is placed.

Alternatively, cellulose nanofibers may be added so as to have a suitable ratio in a solvent in which carbon dioxide gas is dissolved in advance. That is, as the binder for positive electrode, one in which carbon dioxide gas is already dissolved at a desired concentration may be used, or carbon dioxide gas may be blown-in at the time of use.

Since the pressure of carbon dioxide gas varies with various factors such as the amount of cellulose nanofibers contained in the binder for positive electrode, the type of solvent, the temperature of the solvent, the treatment time, and the viscosity, a clear pressure is difficult to specify, but is at least higher than atmospheric pressure. The higher the pressure of carbon dioxide, the more the amount of carbon dioxide contained in the binder for positive electrode tends to increase according to Henry's law.

Note that the dissolved concentration of carbonic acid can be measured by a known method, for example, a titration method.

Here, even when the binder for positive electrode of Comparative Example in which cellulose nanofibers are removed from the binder for positive electrode of the present embodiment is used, the alkali metal hydroxide contained in the positive electrode active material is neutralized by carbonic acid to form an alkali metal carbonate. However, in this case, the surface of the positive electrode active material will be directly coated with an alkali metal carbonate. In particular, since the alkali metal carbonate is dense, the alkali metal carbonate coated with the positive electrode active material suppresses contact between the positive electrode active material and the electrolytic solution. Therefore, the resistance derived from the ionic conductivity is increased, and the input/output characteristics of the battery are deteriorated.

Conversely, when cellulose nanofibers are contained as in the binder for positive electrode of the present embodiment, the denseness of the alkali metal carbonate is weakened, and the electrolytic solution can be held in the vicinity of the positive electrode active material.

In addition, in this embodiment, a binder in which carbon dioxide gas is dissolved in a solvent in which cellulose nanofibers are dispersed has been described as a binder for positive electrode of a nonaqueous electrolyte secondary battery, but the binder may be used as a binder for negative electrode.

However, in the binder of the present embodiment, it is more effective using as a positive electrode. This is because the positive electrode has a smaller volume change accompanying charge and discharge than the negative electrode, and the effect of suppressing the swelling of the cellulose nanofibers is large by coating the surface of the cellulose nanofibers with an alkali metal carbonate. Further, this is because an alkali metal hydroxide is contained in the positive electrode active material, and a defect occurs in which the surface of the positive electrode active material is directly covered with the alkali metal carbonate.

As described above, since both of the cellulose nanofibers and the carbonic acid are contained in the binder for positive electrode, the alkali metal carbonate is precipitated in a state in which the cellulose nanofibers are wound, thereby achieving the above-described effect. However, when the alkali metal hydroxide is not contained as an active material as in the negative electrode, even if carbonic acid is added to the binder, a large effect is not exhibited as much as that of the positive electrode.

The binder for positive electrode of the present embodiment contains cellulose nanofibers, and swelling of the binder for positive electrode in an electrolytic solution at a high temperature can be suppressed to some extent. Further, by including cellulose nanofibers, decomposition of the electrolytic solution can be suppressed.

However, when a binder in which carbon dioxide gas is dissolved is used as a binder for negative electrode in a solvent in which cellulose nanofibers are dispersed, an increase in the thickness of the active material layer is larger in the binder due to a change in volume of the negative electrode active material than in the case of the solvent in which the cellulose nanofibers are dispersed. That is, in the negative electrode, the factor of increasing the resistance is dominated by the volume change of the active material. Therefore, the resistance derived from the electron conductivity of the negative electrode active material layer has a small effect even if the swelling of the negative electrode binder is suppressed. In addition, in the negative electrode, even if cellulose nanofibers are contained, the effect of suppressing the decomposition of the electrolytic solution has not been confirmed.

On the other hand, in the positive electrode, an alkali metal hydroxide is contained in a positive electrode active material composed of an alkali metal element (A), a transition metal element (M), and an oxygen element (O). This alkali metal hydroxide, as described above, causes the binder to gel or corrode the current collector. For this reason, it has been generally the that the alkali metal hydroxide is preferably removed. However, in this embodiment, an alkali metal hydroxide is utilized, and an alkali metal salt which is a neutralization reactant by carbonic acid is generated in a state in which cellulose nanofibers are wound, so that the characteristics of the battery can be improved. Thus, in this embodiment, it is preferable that an alkali metal hydroxide is contained in the positive electrode active material.

The optimum amount of the alkali metal hydroxide in the positive electrode active material varies depending on the concentration of the carbon dioxide gas contained in the binder solvent. When the concentration of carbon dioxide contained in the binder solvent is low, it is preferable that the amount of the alkali metal hydroxide is small. On the contrary, when the concentration of carbon dioxide contained in the binder solvent is high, it is preferable that the amount of the alkali metal hydroxide is large. Specifically, when the concentration of the carbon dioxide gas contained in the binder solvent is 50 mg/L or more and 9000 mg/L or less, the amount of the alkali metal hydroxide relative to the total amount of the positive electrode active material is preferably 0.01% by mass or more and 10% by mass or less. Further, the amount of the alkali metal hydroxide relative to the total amount of the positive electrode active material is more preferably 0.02% by mass or more and 5% by mass or less, and still more preferably 0.05% by mass or more and 2% by mass or less.

When the amount of the alkali metal hydroxide relative to the total amount of the positive electrode active material is less than 0.01% by mass, the cellulose nanofibers cannot be sufficiently coated with the alkali metal salt. In this way, when the amount is less than 0.01% by mass, it is preferable to separately add an alkali metal hydroxide to the positive electrode active material in advance and adjust the amount of the alkali metal hydroxide so as to fall within the above range.

On the contrary, when the amount of the alkali metal hydroxide relative to the total amount of the positive electrode active material exceeds 10% by mass, the amount of the alkali metal salt precipitated on the surface of the cellulose nanofiber increases, and the thickness of the alkali metal salt in the vicinity of the surface of the positive electrode active material increases, so that the input/output characteristics of the battery deteriorate and the capacity density of the electrode decreases.

Thus, according to this embodiment, by placing cellulose nanofibers in the binder for positive electrode, swelling of the binder in an electrolytic solution at a high temperature can be suppressed. Further, since the alkali metal carbonate is coated on the cellulose nanofiber, swelling of the binder for positive electrode can be more effectively suppressed. Further, as described above, the positive electrode hardly causes a change in thickness of the active material layer associated with charging and discharging as compared with the negative electrode. Therefore, suppressing swelling of the binder by an electrolytic solution at a high temperature is effective in improving the high temperature durability of the battery.

Cellulose nanofibers are a group of cellulose fibers in which cellulose, which is a constituent material such as wood, is physically or chemically finely loosened to a maximum fiber diameter of 1 μm or less. It is to be noted that it may be a cellulose nanofiber obtained from an animal, an algae, or a bacterium.

In the present embodiment, the fiber length is a value measured by a fiber length measuring machine (manufactured by KAJAANI AUTOMATION Corporation, FS-200). The fiber diameter can be measured by an equivalent apparatus.

More specifically, it is preferable that the fiber diameter of the cellulose nanofiber is 0.002 μm or more and 1 μm or less, and the fiber length of the cellulose nanofiber is 0.05 μm or more and 1 μm or less, and the aspect ratio (fiber of cellulose nanofiber/fiber diameter of cellulose nanofiber) is 10 or more and 100000 or less. It is more preferable that the cellulose nanofiber has a fiber length of 0.2 μm or more and an aspect ratio (fiber diameter of cellulose/fiber length of cellulose fiber) of 20 or more and 50000 or less.

Usually, cellulose nanofibers are produced using, as a starting material, a cellulose material (cellulose nanofiber precursor), that is, a chemically treated pulp of wood such as kraft pulp or sulfite pulp, a cotton-based pulp such as cotton linter or cotton lint, a non-wood-based pulp such as wheat straw pulp or bagasse pulp, a regenerated pulp regenerated from waste paper, a cellulose isolated from seaweed, an artificial cellulose fiber, a bacterial cellulose fiber by an acetic acid bacterium, a cellulose fiber derived from an animal such as ascidian, and the like.

Although there is no particular limitation on the cellulose nanofibers used in this embodiment, it is preferable to use those corresponding to the above-described fiber diameter, fiber length, and aspect ratio. For example, cellulose nanofiber of the desired size can be produced by microfibrillizing the cellulose material (cellulose nanofiber precursor) described above via a cellulose swelling step by a device such as a homo-mixer, ultrasonic dispersion treatment, beater, refiner, screw-type mixer, paddle mixer, disparmixar, turbine mixer, ball mill, bead mill, grinder, opposed-collision treatment device, hyperbaric homogenizer, water jet, etc.

The cellulose swelling step (Step (A)) may be performed, for example, by adding a cellulose material (cellulose nanofiber precursor) to a liquid medium having a hydroxyl group (—OH group, hydroxyl group) which functions as a swelling agent and a dispersion solvent. As a liquid medium having a hydroxyl group, it is preferable to be water and/or alcohols because it is easily mixed with NMP in a step (B) to be described later, and the cellulose nanofibers hardly cause aggregation or sedimentation, and the concentration of NMP is effectively increased in a step (C) to be described later. Examples of the alcohols include methanol, ethanol, propanol, and butanol. Here, when the total amount of cellulose and a liquid medium having a hydroxyl group is set to 100% by mass, the cellulose is preferably set to 0.1% by mass or more and 20% by mass or less, and more preferably 1% by mass or more and 15% by mass or less.

The cellulose nanofibers thus microfibrillated contain a large amount of a liquid medium having a hydroxyl group. Therefore, as a binder for positive electrode, a nonaqueous binder is hardly applied. For example, even if a microfibrillated cellulose nanofiber containing a large amount of the above liquid medium is mixed with a thermoplastic fluororesin (thermoplastic resin) dissolved in NMP, the thermoplastic fluororesin is salted out with water or alcohols and cannot effectively function as a nonaqueous binder. Further, even when the thermoplastic fluororesin is mixed with the above-mentioned liquid medium, the cellulose nanofiber cannot be contained inside the thermoplastic fluororesin, and only becomes a mere mixture of the thermoplastic fluororesin and the cellulose nanofiber. Therefore, it is not possible to effectively suppress swelling of the electrode active material layer in an electrolytic solution at a high temperature.

That is, it is preferable to composite the cellulose nanofibers with a thermoplastic fluororesin. Here, “composite” is a concept different from “mixing”, and a mixture is merely an assembly of cellulose nanofibers and a thermoplastic fluororesin, whereas a composite (binder) is present in a state in which cellulose nanofibers are dispersed in a matrix of a thermoplastic fluororesin. For example, a binder contained in a cellulose nanofiber inside a thermoplastic fluororesin is a composite binder.

In order to obtain such a composite binder, it is preferable to use a liquid in which cellulose nanofibers are dispersed in NMP. However, as described above, since the microfibrillated cellulose nanofibers are in a state containing a large amount of a liquid medium having a hydroxyl group, it is necessary to make this a liquid in which cellulose nanofibers are dispersed in NMP.

On the other hand, in a liquid in which cellulose nanofibers are dispersed, since cellulose nanofibers are irreversibly aggregated by heat treatment, filtration, or the like, it is not preferable to remove a liquid medium having a hydroxyl group by heat treatment, filtration, or the like. In other words, even when cellulose nanofibers obtained by heat treatment, filtration, or the like are added to NMP, good dispersibility cannot be obtained.

Therefore, while maintaining a dispersed liquid state in a cellulose nanofiber dispersed in a liquid medium having a hydroxyl group such as water and/or alcohols, it is preferable to replace the above liquid medium with NMP.

The above substitution can be performed by the following steps (B) and (C). NMP is added to the above liquid medium in which cellulose nanofibers are dispersed, and a mixed liquid containing cellulose nanofibers and the above liquid medium and NMP is formed (Step (B)). At this time, when the total of the above liquid medium and NMP is set to 100% by mass, a mixed liquid is formed so that the cellulose nanofiber (solid content) is 0.1% by mass and more and 20% by mass or less. Then, while stirring the above mixed liquid, the concentration of NMP is increased by evaporating the above liquid medium (water and/or alcohols, etc.) (Step (C)). In this way, a liquid in which cellulose nanofibers are dispersed in NMP can be formed.

In the above step (C), it is preferable to remove the above liquid medium (water and/or alcohols, etc.) by heating under reduced pressure. Specifically, in the above step (C), it is preferable to evaporate the above liquid medium (water and/or alcohols or the like) to increase the concentration of NMP under conditions of 25° C. or more and 150° C. or less, and 10 hPa or more and 900 hPa or less. According to such a method, it is possible to efficiently remove the above-mentioned liquid medium and to obtain a liquid in which cellulose nanofibers are dispersed in NMP having high purity. When the pressure exceeds 900 hPa, it is difficult to remove the liquid medium unless the heating temperature is increased, and NMP is also easily vaporized at the same time as the liquid medium. When the pressure is less than 10 hPa, the NMP is easily vaporized even at room temperature, for example, 25° C., and the apparatus required for decompression becomes large. Further, the pressure is more preferably 50 hPa or more and 800 hPa or less, and still more preferably 100 hPa or more and 700 hPa or less. Within this pressure range, by setting the temperature to 25° C. or higher and 150° C. or less, it is possible to effectively remove the above liquid medium. Here, by setting the temperature to 150° C. or less, not only the vaporization of NMP is suppressed but also yellowing (discoloration) of the cellulose nanofibers is suppressed, so that the flexibility and the decrease in mechanical strength of the cellulose nanofibers can be prevented. In addition, by setting the temperature to 25° C. or more, the removal rate of the liquid medium can be increased.

In addition, after the step (C), it is preferable to perform a step (step (D)) of irradiating the liquid in which the cellulose nanofibers are dispersed in the NMP with ultrasonic waves having an oscillation frequency of 10 kHz or more and 200 kHz or less and an amplitude of 1 μm or more and 200 μm or less. It is more preferable that the ultrasonic wave to be irradiated has an oscillation frequency of 15 kHz or more and 100 kHz or less, and an amplitude of 10 μm or more and 100 μm or less. According to the ultrasonic irradiation under such conditions, the cellulose nanofibers are uniformly fiberized by the generated cavitation shock wave, and the dispersibility and storage stability are improved. The irradiation time of the ultrasonic wave is not particularly limited, but is preferably 1 minute or more, more preferably 3 minutes or more and 60 minutes or less.

In the binder for positive electrode in which cellulose nanofibers are complexed with a thermoplastic fluororesin, the content of cellulose nanofibers is preferably set as follows. When the total of the solid content of the cellulose nanofiber and the thermoplastic fluorine-based resin is set to 100% by mass, it is preferable that the cellulose nanofiber is contained in an amount of 5% by mass or more and 80% by mass or less, and the thermoplastic fluorine-based resin is 20% by mass or more and 95% by mass or less. According to this configuration, it further functions as an electrode binder having excellent output characteristics. In addition, aggregation, sedimentation, and the like hardly occur in the manufacturing process of the slurry, and the yield at the time of manufacturing the electrode is improved.

When the total of the solid content of the cellulose nanofiber and the thermoplastic fluorine-based resin is set to 100% by mass, by adjusting the cellulose nanofiber so that the cellulose nanofiber is 5% by mass or more and the thermoplastic fluorine-based resin is 95% by mass or less, the electrolytic solution swelling resistance is improved, and the cycle life characteristics and the output characteristics at high temperature are improved. The reason for this is considered to be that, in the binder for positive electrode, since cellulose nanofibers are dispersed in a matrix of a thermoplastic fluorine-based resin, cellulose nanofibers suppress swelling of a thermoplastic fluorine-based resin in an electrolytic solution.

When the total of the solid content of the cellulose nanofiber and the thermoplastic fluorine-based resin is set to 100% by mass, by adjusting so that the cellulose nanofiber is 80% by mass or less and the thermoplastic fluorine-based resin is 20% by mass or more, the thermoplastic fluorine-based resin in the binder for positive electrode absorbs the electrolytic solution at a high temperature, but the swelling of the positive electrode active material layer is suppressed by the cellulose nanofiber. Therefore, the conductive network of the positive electrode active material layer is hardly destroyed, ion conductivity can be imparted to the binder for positive electrode, and output characteristics can be improved.

Therefore, although only the thermoplastic fluorine-based resin can absorb the electrolytic solution at high temperature to impart ionic conductivity to the binder, swelling of the electrode active material layer cannot be suppressed, and the conductive network of the electrode active material layer is destroyed. Therefore, by adding cellulose nanofibers (5% by mass or more), the above defect can be suppressed. In addition, although only cellulose nanofibers can suppress swelling of the electrode active material layer at high temperature, ion conductivity becomes poor. Therefore, by adding (20% by mass or more) a thermoplastic fluorine-based resin which absorbs an electrolytic solution, ion conductivity can be improved.

The content of the cellulose nanofiber and the thermoplastic fluorine-based resin is more preferably 10% by mass or more and 75% by mass or less of the cellulose nanofiber, and 25% by mass or more and 90% by mass or less of the thermoplastic fluorine-based resin, and still more preferably 20% by mass or more and 70% by mass or less of the cellulose nanofiber, and 30% by mass or more and 80% by mass or less of the thermoplastic fluorine-based resin.

It is preferable that the cellulose nanofibers be subjected to defibration treatment with chemical treatment, physical treatment or both of these, and have the above-mentioned fiber diameter. The chemical treatment is carried out by adding one or more kinds of reagents having a pH value of 0.1 or more and 13 or less and a melting point of 20° C. to 200° C. The physical treatment is performed using a grinder, a bead mill, an opposed collision processing device, a high pressure homogenizer, a water jet, or the like described above.

Further, it is preferable to perform a hydrophobizing treatment before and after or at the same time with the defibration treatment of the cellulose nanofibers used in this embodiment. A hydroxyl group of cellulose is subjected to a hydrophobizing treatment (lipophilic treatment) using an additive (e.g., a carboxylic acid-based compound)

The additive is not particularly limited as long as it has a composition capable of imparting a hydrophobic group to a hydrophilic group of cellulose, but for example, a carboxylic acid-based compound can be used. Among them, it is preferable to use a compound having 2 or more carboxyl groups, an acid anhydride of a compound having 2 or more carboxyl groups, and the like. Among the compounds having 2 or more carboxyl groups, a compound having 2 carboxyl groups (dicarboxylic acid compound) is preferably used.

As compounds with two carboxy groups: propanediacid (malonic acid), butanediacid (succinic acid), pentanedioacid (glutaric acid), hexanediacid (adipic acid), 2-methylpropanediacid, 2-methylbutanediacid, 1,2-cyclohexanedicarboxylic acid, 2-butenediacid (maleic acid, fumaric acid), 2-pentenedioic acid, 2-methyl-2-butenediacid, Dicarboxylic acid compounds such as 2-methylidene butanedioic acid (itaconic acid), benzene-1,2-dicarboxylic acid (phthalic acid), benzene-1,3-dicarboxylic acid (isophthalic acid), benzene-1,4-dicarboxylic acid (terephthalic acid), and ethanedioic acid (oxalic acid) can be mentioned. Acid anhydrides of compounds having two carboxy groups include dicarboxylic acid compounds such as maleic anhydride, succinic anhydride, phthalic anhydride, glutaric anhydride, adipic anhydride, itaconic anhydride, pyromellitic anhydride, 1,2-cyclohexanedicarboxylic anhydride, and acid anhydrides of compounds containing multiple carboxy groups. Examples of the derivative of the acid anhydride of the compound having two carboxy groups include those in which at least a part of hydrogen atoms of an acid anhydride of a compound having a carboxy group is substituted with a substituent (e.g., an alkyl group, a phenyl group, or the like), such as dimethylmaleic anhydride, diethylmaleic anhydride, and diphenylmaleic anhydride. Of these, maleic anhydride, succinic anhydride and phthalic anhydride are preferred because they are easily applied industrially and easily gasified.

For example, a portion of the hydroxyl group is replaced with a carboxyl group by a chemical modification treatment (primary treatment) such as a polybasic acid half ester (SA) treatment. By using such a hydrophobized cellulose nanofiber, a repulsive force can be attracted between the cellulose nanofibers by the carboxyl (—COOH) group on the surface of the cellulose nanofiber. This polybasic acid semi-esterification treatment is a treatment in which a polybasic acid anhydride is semi-esterified into a part of a hydroxyl group of cellulose to introduce a carboxyl group into a surface of cellulose.

As described above, by using hydrophobized cellulose nanofibers as the cellulose in the binder for positive electrode, swelling of the positive electrode active material layer can be suppressed even in the electrolyte at 80° C. or higher, and cycle life characteristics and output characteristics can be improved even at a high temperature. Further, by using a hydrophobized cellulose nanofiber as the cellulose in the binder for positive electrode, even if the ratio of the thermoplastic fluorine-based resin is reduced, aggregation, sedimentation, and the like can be suppressed in the step of forming the slurry. As a result, the yield at the time of manufacturing the electrode is improved. Further, as compared with a case where an untreated cellulose nanofiber is used, as the cellulose in the binder for positive electrode, it is possible to make the carbon dioxide gas dissolved in the solvent less likely to be removed.

The step of subjecting the hydroxyl group (—OH group, hydrophilic group) of the cellulose nanofiber to a hydrophobizing treatment is not particularly limited, and the number of times of treatment may be performed by 1 time or a plurality of times of hydrophobizing treatments.

It is preferable that the hydrophobizing treatment chemical modification treatment) is performed before the process (B). At this time, the pH values of the liquid obtained in step (B) and step (C) are preferably in a range of 0.1 or more and 11 or less. The hydrophobizing treatment (chemical modification treatment) is preferably mixed using a pressure kneader or a kneader having a single axis or more at a temperature of 80° C. or higher and 150° C. or less.

A composite obtained by complexing cellulose nanofibers with a thermoplastic fluororesin can be obtained by dissolving a thermoplastic fluorine-based resin in a liquid in which cellulose nanofibers are dispersed in NMP. Thus, a liquid in which a thermoplastic fluorine-based resin is dissolved in NMP and a cellulose nanofiber is dispersed is obtained. Further, a composite obtained by complexing cellulose nanofibers with a thermoplastic fluororesin can be obtained by mixing a liquid in which cellulose nanofibers are dispersed in NMP and a thermoplastic fluorine-based resin dissolved in NMP. Further, the above composite can be obtained by mixing cellulose nanofibers and a thermoplastic fluorine-based resin and dissolving the thermoplastic fluorine-based resin in NMP.

Examples of the above thermoplastic fluorine-based resin include polyvinylidene fluoride (PVdF), vinylidene fluoride copolymer, polytetrafluoroethylene (PTFE), polyvinyl fluoride, polytrifluoroethylene, polytrifluoroethylene, vinylidene fluoride/ethylene trifluoride copolymer, vinylidene fluoride/ethylene tetrafluoride copolymer, and tetrafluoroethylene/propylene hexafluoride copolymer. 1 or 2 or more of these resins may be used. In addition, in these resins, it may be a homopolymer, a copolymer, or a terpolymer. Of these, polyvinylidene fluoride (PVdF) is preferably contained from the viewpoint of high ionic conductivity of the electrode and excellent oxidation resistance and reduction resistance characteristics.

From the viewpoint of easily retaining an electrolytic solution and excellent binding property with a current collector, PVdF preferably has an average molecular weight (number average molecular weight:Mn) of 100000 or more and 5 million or less. When the average molecular weight is less than 100000, the binding property with the current collector is not sufficient, and the viscosity of the binder becomes low. As a result, it becomes difficult to obtain an electrode having a high basis capacity by increasing the application amount per unit area. When the average molecular weight exceeds 5 million, it is difficult to dissolve in NMP, and since the viscosity of the binder increases, heat generation becomes severe during mixing of the slurry. Therefore, the cooling of the slurry does not catch up (not kept below 80° C.), the slurry is easily gelled. The gels are formed by reacting PVdF with moisture in the air or solution. A more preferable average molecular weight of PVdF is 110000 or more and 3 million or less, and a further preferable average molecular weight is 120000 or more and 1.5 million or less.

PVdF is obtained by suspension polymerization or emulsion polymerization of 1,1-difluoroethylene in a suitable reaction medium together with an additive such as a polymerization initiator, a suspending agent, or an emulsifier. The molecular weight of this PVdF can be adjusted using known polymerization adjusting agent, and chain transfer agent, or the like.

In this embodiment, the number average molecular weight means a result measured by gel permeation chromatography which is widely used as a molecular weight measurement method of a polymer. For example, it can be measured by an ultraviolet detector using an NMP in which 0.01 mol/L of lithium bromide is dissolved in a HLC8020 device manufactured by Tosoh Corporation.

The binder for positive electrode of the present embodiment is a binder in which a thermoplastic fluorine-based resin is dissolved in NMP and a cellulose nanofiber is dispersed in NMP, and a ratio of a solid content is preferably 3% by mass or more and 30% by mass or less. In other words, when the total mass of the cellulose nanofibers and the thermoplastic fluorine-based resin and the NMP in the binder is set to 100% by mass, the total of the cellulose nanofibers and the thermoplastic fluorine-based resin is preferably 3% by mass or more and 30% by mass or less. Here, in order to avoid contact between an active material containing an alkali metal element (e.g., Li) and water, it is preferable that the content of water in the NMP is as small as possible. Specifically, it is preferably 1000 ppm or less, more preferably 500 ppm or less, and still more preferably 100 ppm or less.

According to the binder for positive electrode of the present embodiment, gelation hardly occurs when a slurry is produced by adding an active material containing an alkali metal element. In addition, it is difficult to cause aggregation, sedimentation, and the like in the manufacturing process of the slurry. In addition, the coating property of the positive electrode is improved. Further, the yield at the time of manufacturing the positive electrode is improved.

For example, using the binder for positive electrode of the present embodiment as a binder for positive electrode for a lithium ion battery to be deposited and formed on a current collector such as aluminum, it is possible to function satisfactorily as a positive electrode for a lithium ion battery. Note that it may be used as a binder for electrode of a reference electrode. It may also be used as a binder for positive polarity used in storage devices such as electrical double-layer capacitors, ion capacitors, Na-ion battery, Magnesium-ion battery, Calcium-ion battery, Alkali secondary battery, and primary battery.

The positive electrode has, for example, a positive electrode active material and a conductive auxiliary agent other than the binder of the present embodiment.

The positive electrode can be formed as follows. For example, a positive electrode mixture slurry is formed by adding water, NMP, or the like as a slurry solvent to a mixture (electrode mixture) containing a positive electrode active material, a conductive auxiliary agent, a binder, and the like and sufficiently kneading the mixture as a slurry solvent. By applying and drying a positive electrode mixture slurry on the surface of the current collector, a positive electrode having a desired thickness and density can be formed.

The nonaqueous electrolyte secondary battery on which the positive electrode is mounted can be manufactured as follows. By using the battery elements of the nonaqueous electrolyte secondary battery (counter electrode, separator, electrolyte solution, etc.), it is possible to manufacture a nonaqueous electrolyte secondary battery of a laminate type or a wound type according to a conventional method.

As the conductive auxiliary agent for the positive electrode, there is no particular limitation as long as it has conductivity (electrical conductivity), and metal, carbon material, conductive polymer, conductive glass, or the like can be used. Of these, it is preferable to use a carbon material for the reason that an improvement in conductivity is expected in the positive electrode active material with a small amount of addition. Specifically, acetylene black (AB), Ketjen black (KB), furnace black (FB), thermal black, lamp black, Chennel black, roller black, disc black, carbon black (CB), carbon fibers (for example, vapor grown carbon fibers named VGCF, a registered trademark), carbon nanotubes (CNTs), carbon nanohorns, graphite, graphene, glassy carbon, amorphous carbon, and the like can be used. Of these, one kind or two or more kinds may be used as the conduction aid.

The content of the conductive auxiliary agent of the positive electrode is preferably 0 to 20% by mass, when the total of the positive electrode active material, the binder, and the conductive auxiliary agent is set to 100% by mass. In other words, the conductive auxiliary agent is contained if necessary, and when the amount is more than 20% by mass, since the ratio of the active material as a battery is small, the electrode capacity density tends to be low.

The binder for positive electrode of the present embodiment is not particularly limited as long as it has cellulose and a solvent and carbon dioxide gas are dissolved. As a material which may be included other than these, it is generally used as a binder for electrode, for example, fluororesin, polyimide, polyamideimide, aramid, ethylene-vinyl acetate copolymer (EVA), styrene-ethylene-butylene-styrene copolymer (SEBS), polyvinyl butyral (PVB), ethylene vinyl alcohol, polypropylene (PP), epoxy resin, polyethylene terephthalate (PET), polybutylene terephthalate (PBT), nylon, vinyl chloride, silicone rubber, nitrile rubber, Cyanoacrylate, urea resin, phenol resin, polyvinylpyrrolidone, vinyl acetate, polystyrene, chloropropylene, resorcinol resin, polyaromatic, modified silicone, polybutene, butyl rubber, 2-propenoic acid, and the like. Of these, 1 kind may be included as a resin, and 2 or more kinds may be included as a resin.

As a material which may be included other than the above, inorganic particles such as ceramics and carbon may be contained. In this case, the particle size of the ceramic or carbon is preferably within a range of 0.01 to 20 μm, and more preferably within a range of 0.05 to 10 μm. In the present embodiment, the particle size means the volume-based median diameter (D50) in the laser diffraction and scattering particle size distribution measurement method.

The content of the binder for positive electrode of the present embodiment is preferably 0.1% by mass or more and 60% by mass or less, more preferably 0.5% by mass or more and 30% by mass or less, and still more preferably 1% by mass or more and 15% by mass or less, when the total of the positive electrode active material, the binder, and the conductive auxiliary agent is set to 100% by mass. Note that, when the positive electrode mixture slurry is adjusted, the carbon dioxide gas contained in the binder for positive electrode is vaporized in the drying step, and therefore, it is negligible as a solid content.

When the binder for positive electrode is less than 0.1% by mass, the mechanical strength of the electrode is low, so that the positive electrode active material easily falls off, and the cycle life characteristic of the battery may be deteriorated. On the other hand, when the positive electrode binder exceeds 60% by mass, the ion conductivity is low, the electric resistance is high, and the ratio of the active material as the battery is small, so that the electrode capacity density tends to be low.

The current collector used for the positive electrode is not particularly limited as long as it has conductivity and can be brought into conduction with the held positive electrode active material. As the material of the current collector, for example, conductive materials such as C, Ti, Cr, Ni, Cu, Mo, Ru, Rh, Ta, W, Os, Ir, Pt, Al, Au, and Fe, and an alloy containing two or more of these conductive materials (e.g., stainless steel) can be used. In addition, as the current collector (for example, Al coated with C), it may be a multilayer structure of different materials.

From the viewpoint of high conductivity and good stability in the electrolytic solution, as the material of the current collector, C, Ti, Cr, Au, Al, preferably stainless steel or the like are preferred, and from the viewpoint of material cost, Al, and stainless steel or the like are more preferred. Note that when stainless steel is used as the current collecting base material, it is preferable to use a material coated with C in order to prevent electrochemical oxidation of the surface of the current collecting base material due to the positive electrode potential.

There is no particular limitation on the shape of the current collector, but there is a foil-like base material, a three-dimensional base material, or the like, and these may be a base material having through holes. Of these, it is preferable to use a three-dimensional base material because the packing density of the positive electrode active material can be increased. Examples of the three dimensional substrate include a mesh, a woven fabric, a nonwoven fabric, an embossed body, an expanded body, or a foam, and among them, an embossed body or a foam is preferably used because of their good output characteristics.

Further, as this positive electrode, a positive electrode obtained by penetrating an inorganic skeleton forming agent into a positive electrode active material layer by coating an inorganic skeleton forming agent on a positive electrode active material layer or the like described in Patent Document 8 (Japanese Patent No. 6149147) may be used. As a result, the high temperature durability of the positive electrode can be further improved.

When the inorganic skeleton forming agent is applied to the positive electrode active material layer, the inorganic skeleton forming agent in the electrode is preferably 0.001 mg/cm² or more and 10 mg/cm² or less, and more preferably 0.01 mg/cm² or more and 3 mg/cm² or less in the case of single-sided coating. In the case of double-sided coating, or in an electrode in which active material layers are filled in a three-dimensional base material, the above skeleton forming agent per unit area of the electrode is preferably 0.002 mg/cm² or more and 20 mg/cm² or less, and more preferably 0.02 mg/cm² or more and 6 mg/cm² or less.

The inorganic skeleton forming agent may be silicate-based, phosphate-based, sol-based, cement-based, or the like. For example, lithium silicate, sodium silicate, potassium silicate, cesium silicate, guanidine silicate, ammonium silicate, silicone fluoride, borate, lithium aluminate, sodium aluminate, potassium aluminate, aluminosilicate, lithium aluminate, aluminum aluminate, aluminum polysulfate, aluminum sulfate, aluminum nitrate, ammonium alum, chromium alum, iron alum, manganese, boron, boron sulphate silica sol, colloidal silica, alumina sol, colloidal alumina, fumed alumina, zirconia sol, colloidal zirconia, fumed zirconia, magnesia sol, colloidal magnesia, fumed magnesia, calcisol, colloidal calcia, fumed calcia, titania sol, colloidal titania, fumed titania, zeolites, silicoaluminophosphate zeolites, cepiolites, montmorinites, kaolins, saponites, aluminum phosphates, magnesium phosphates, calcium phosphates, copper phosphates, zinc phosphates, titanium phosphates, manganese phosphates Inorganic materials such as silica cement, phosphate cement, concrete, and solid electrolyte can be used. Of these, 1 kind may be used alone, and 2 or more kinds thereof may be used in combination.

Further, as the content of the inorganic skeleton forming agent, when the total of the positive electrode active material, the binder, and the conductive auxiliary agent is set to 100% by mass, the content is preferably 0.01% by mass or more and 50% by mass or less, more preferably 0.1% by mass or more and 30% by mass or less, and still more preferably 0.2% by mass or more and 20% by mass or less.

The slurry (positive electrode slurry) using the binder for positive electrode of the present embodiment, even when a positive electrode active material containing an alkali metal element is used, gelation hardly occurs. Therefore, an active material capable of storing and releasing alkali metal ions used in a nonaqueous electrolyte secondary battery can be used as a positive electrode active material.

Here, the positive electrode active material containing an alkali metal is a compound containing at least an alkali metal element (A), a transition metal element (M), and an oxygen element (0), and includes, for example, ACoO₂, ANiO₂, AMnO₂, NCM, NCA, AMn₂O₄, AFePO₄, A₄Ti₅O₁₂, A₂MnO₃-AMO₂ (M=Ni, Co, Mn, Ti), A₂MSiO₄ (Fe, Ni, Co, Mn) (A=alkali metal element).

As described above, a positive electrode can be formed by coating and drying a positive electrode mixture slurry on the surface of a current collector. The positive electrode mixture slurry may be applied or filled into the current collector. After this, it is temporarily dried, after press adjustment, it may be subjected to heat treatment at 60° C. or higher and 280° C. or less. Temporary drying is not particularly limited as long as the solvent in the slurry can be evaporated and removed, for example, heat treatment is performed under a temperature atmosphere of 50° C. or higher and 200° C. or less in air. Carbon dioxide gas in the slurry is vaporized in the process of temporary drying.

Further, the heat treatment after press adjustment (after rolling), by making 60° C. or higher 280° C. or less, the solvent and moisture in the slurry is removed as much as possible, and carbonization of the binder (particularly carbonization of cellulose nanofibers) can be prevented. As heat treatment temperature, 100° C. or more and 250° C. or less are preferable, 105° C. or more and 200° C. or less are more preferable, and 110° C. or more and 180° C. or less are still more preferable.

The heat treatment time can be 0.5 to 100 hours. The atmosphere at the time of heat treatment may be an atmosphere or a non-oxidizing atmosphere. The non-oxidizing atmosphere means an environment in which the abundance of oxygen gas is less than in air. For example, a reduced-pressure environment, a vacuum environment, a hydrogen gas atmosphere, a nitrogen gas atmosphere, a rare gas atmosphere, or the like may be used.

Note that, although there is a negative electrode and a positive electrode in the electrode, the negative electrode and the positive electrode can be manufactured by the same process only by differing mainly in the current collector and the active material.

In addition, in the case of a positive electrode using a material having an irreversible capacity, it is preferable that the irreversible capacity is canceled by doping of an alkali metal element (e.g., Li). The doping method of the alkali metal element (e.g., Li) is not particularly limited, for example, (i) a method of forming a local cell by sticking a metal lithium to a portion without a positive electrode mixture (positive electrode active layer) on a current collector, and doping an alkali metal element (e.g., Li) in the positive electrode active material, (ii) a method of forcing a short circuit by sticking an alkali metal element (e.g., Li) on the positive electrode mixture, and doping an alkali metal element (e.g., Li) in the positive electrode active material, (iii) a method of forming a film of an alkali metal element (e.g., Li) on the positive electrode mixture by vapor deposition or sputtering, and doping lithium in a positive electrode active material in a solid state reaction, (iv) a method of doping an alkali metal element (e.g., Li) in an electrolytic solution, and (v) a method of doping an alkali metal element (e.g., Li) to the positive electrode material by adding and mixing the alkali metal element (e.g., Li) to the positive electrode active material powder, and the like.

In addition, the binder for positive electrode of the present embodiment can be used as a coating film to be coated on the surface of the separator. This binder is referred to as “a binder for coating film of a separator”. By providing such a coating film, the strength and heat resistance of the separator can be improved. In addition, the adhesion between the electrode and the separator can be improved. Further, it is possible to improve the cycle life characteristics of the battery. Further, since the carbon dioxide gas contained in the binder for coating film of the separator is foamed when vaporized in the drying step of the coating film, it becomes a separator excellent in lyophilicity. The binder for coating film of the separator according to the present embodiment can be coated on one side or both sides of the separator base material (raw material) or can be filled in the separator base material. Here, as the separator base material, a material commonly used in a non-aqueous electrolyte secondary battery such as a lithium ion battery can be used. For example, the thickness of the separator substrate may be within a range of 1 to 50 μm.

In the battery using the binder for positive electrode of the present embodiment, for example, the positive electrode and the negative electrode using the binder for positive electrode of the present embodiment and the separator therebetween are stacked or laminated and sealed in a state of being immersed in the electrolyte solution. The structure of the battery is not limited thereto and is applicable to batteries such as a laminated type and a wound type.

The negative electrode may include a negative electrode active material capable of alloying with an alkali metal or a negative electrode active material capable of storing an alkali metal ion. The negative electrode active material is more than 1 or more element selected from the group consisting of, for example, Li, Na, K, C, Mg, Al, Si, P, Ca, Sc, Ti, V, Cr, Mn, Fe, Co, Ni, Cu, Zn, Ga, Ge, Y, Zr, Nb, Mo, Pd, Ag, Cd, In, Sn, Sb, W, Pb, and Bi, alloys, composites, oxides, chalcogenides or halides using these elements.

From the viewpoint that the area of the discharge plateau can be observed within the range of 0 to 1V (vs. Li/Li⁺), it is preferable to use one or more elements selected from the group consisting of Li, Na, K, C, Mg, Al, Si, Ti, Zn, Ge, Fe, Mn, Ag, Cu, In, Sn, and Pb, or an allotrope, alloy, or oxide of these elements.

Further, from the viewpoint of high energy density and excellent high temperature durability, it is preferable to use a Si-based material (a material containing Si as an element). For example, as the Si-based material, a single Si, a Si alloy, a Si oxide, or the like can be given.

The Si-based material preferably has a median diameter (D50) of 0.1 μm or more and 10 μm or less, and an oxygen content contained in the Si-based material is 30% by mass or less.

However, when an Si-based material is used as a negative electrode active material, lithium is preferably used as an ion responsible for electrical conduction of a battery.

The battery may be a non-aqueous electrolyte secondary battery in which an electrode including the binder for positive electrode of this embodiment mode is used as at least the positive electrode.

The electrolyte used in this battery may be any liquid or solid capable of transferring alkali metal ions from a positive electrode to a negative electrode or from a negative electrode to a positive electrode, and the same electrolyte used in a known nonaqueous electrolyte secondary battery can be used. Examples thereof include an electrolytic solution, a gel electrolyte, a solid electrolyte, an ionic liquid, and a molten salt. Here, the electrolytic solution refers to a solution in which an electrolyte is dissolved in a solvent.

The electrolytic solution is not particularly limited as long as it is used in a nonaqueous electrolyte secondary battery, but is composed of an electrolyte salt and an electrolyte solvent because it is necessary to contain an alkali metal ion.

As the electrolyte salt, an alkali metal salt such as a lithium salt, a sodium salt, or a potassium salt is suitable. As the alkali metal salt, at least one kind selected from the group consisting of hexafluorophosphoric acid compound (APF₆), perchloric acid compound (AClO₄), tetrafluoroborate compound (ABF₄), trifluoromethanesulfonic acid compound (ACF₃SO₄), alkali metal bistrofluoromethanesulfonylimide (AN (SO₂CF₃)₂), alkali metal bispentafluoroethanesulfonylimide (AN (SO₂C₂F₅)₂), alkali metal bisoxalate borate (ABC₄O₈), and the like can be used (A=alkali metal element). Among the above alkali metal salts, APF₆ is particularly preferable because of its high electronegativity and easy ionization. When the electrolyte solution contains APF₆, the charge-discharge cycling characteristics are excellent, and the charge-discharge capacities of the secondary batteries can be improved.

As the electrolyte solvent, for example, at least one selected from the group consisting of propylene carbonate (PC), ethylene carbonate (EC), dimethyl carbonate (DEC), ethyl methyl carbonate (EMC), diphenyl carbonate, γ-butyrolactone (GBL), methylformate (MF), 2-methyltetrahydrofuran, 1,3-dioxolane, dimethoxyethane (DME), 1,2-diethoxyethane, diethyl ether,Tetrahydrofuran (THF), methylsulfolane, dimethylformamide N,N—, dimethyl sulfoxide, vinylene carbonate (VC), vinyl ethylene carbonate (FEC), and ethylene sulfite (ES) can be used. Of these, at least one selected from the group consisting of PC, EC, DMC, DEC, and EMC is preferably used. In particular, a mixture of circular carbonates such as EC, PC and the like described above and chain carbonates such as DMC, DEC, EMC is suitable. The mixing ratio of the circular carbonate and the chain carbonate can be arbitrarily adjusted in the range of 10 to 90% by volume for both the circular carbonate and the chain carbonate.

As an electrolyte solvent, it is preferable to further contain VC or ECV, FEC, and ES. The content of VC or ECV, FEC, and ES is preferably from 0.1 to 20% by mass, more preferably from 0.2 to 10% by mass, when the electrolytic solution (total amount of electrolyte and electrolyte solvent) is set to 100% by mass.

The concentration of the electrolyte salt in the electrolytic solution is preferably 0.5 to 2.5 mol/L, and more preferably 0.8 to 1.6 mol/L

In particular, it is preferable that the electrolytic solution contains at least APF₆ as an electrolyte salt and contains an aprotic circular carbonate and an aprotic chain carbonate as an electrolyte solvent. A battery using an electrolytic solution having this composition and a binder for positive electrode (including a thermoplastic fluororesin) of this embodiment forms a polymer gel of an electrolyte in which a thermoplastic fluororesin of a binder for positive electrode absorbs a hexafluorophosphoric acid compound as an electrolytic solution and an aprotic carbonate by heating to 50° C. or higher, thereby forming a polymer gel of an electrolyte having excellent ionic conductivity.

In particular, in the electrode using the binder for positive electrode of the present embodiment, since the carbon dioxide gas is foamed in the drying step of the slurry and becomes a porous electrode, the electrolytic solution is easily retained. Therefore, a battery using a binder for positive electrode (including a thermoplastic fluororesin) of this embodiment can easily form a polymer gel by heating to 50° C. or higher.

Further, by this polymer gel, it is possible to integrate the positive electrode and the separator which is physically in contact therewith. By integrating them, the adhesion strength between the positive electrode and the separator is increased, the safety of the battery is improved. For example, positional deviation between the separator and the positive electrode due to external factors such as vibration and impact can be effectively prevented, which contributes to the improvement of the safety of the battery.

Here, even when a binder for positive electrode (including a thermoplastic fluororesin) of Comparative Example in which cellulose nanofibers are removed from a binder for positive electrode of this embodiment is used, a thermoplastic fluororesin is gelated by increasing the temperature. However, since the electrode active material layer also swells and the conductive network is destroyed simultaneously with gelation, the resistance of the electrode increases. In addition, once, the thermoplastic fluororesin swollen with the electrolytic solution does not return to the electrode in the original state again.

In other words, while the cellulose nanofibers contained in the binder for positive electrode of the present embodiment suppress swelling of the electrode, by gelating the thermoplastic fluororesin, the positive electrode and the separator are adhesively bonded via the binder while suppressing an increase in the resistance of the electrode, so that a battery having good characteristics can be manufactured.

In the present embodiment, integration means a state in which electrodes and separators which should originally be separated are adhered to each other by heating, and are fixed to each other, so that peeling is difficult. More specifically, when the laminate of the electrodes and the separator is peeled off at angles of 180 degrees in accordance with JISZ0237 standard, the adhesive force is 0.01N/25 mm or more, and when peeled off, the weight of the separator fluctuates 0.1 mg/cm² or more. Or, it means a state in which the separator is broken by elongation or cutting instead of mass fluctuation. The mass variation of the separator means a phenomenon in which a separated member (an electrode active material layer, a separator base material, or a separator coating layer) adheres to the opposite side, thereby causing a change in mass.

As a battery in which an electrode and a separator are integrated, any nonaqueous electrolyte secondary battery using a binder for positive electrode (including a thermoplastic fluororesin) of this embodiment at least at a positive electrode may be used.

Such a battery can be manufactured, for example, by the following steps. First, an electrode group laminated or wound between a positive electrode and a negative electrode via a separator is introduced or encapsulated and sealed in a battery case or container together with an electrolytic solution containing lithium hexafluorophosphate and an aprotic carbonate. Next, the battery case or container is heated so that the temperature of the battery case or container becomes 50° C. or more and 120° C. or less, and pressure is applied from the outside of the battery case or container perpendicularly to the extension direction of the electrodes. Thus, a positive electrode having a binder in which a thermoplastic fluorine-based resin and a cellulose nanofiber are combined and a separator are integrated. A more preferable temperature of the battery case or container is 55° C. or higher and 95° C. or less.

By setting the temperature of the battery case or container to 50° C. or higher, the binder for positive electrode (including a thermoplastic fluororesin) of the present embodiment absorbs the electrolytic solution and is gelated, thereby improving the ionic conductivity of the positive electrode. When the temperature exceeds 120° C., the electrolytic solution is vaporized and tends to contain gas inside the battery. In addition, when the separator contains a polyolefin-based resin, the polyolefin-based resin softens and the risk of short-circuit the battery increases.

By applying a pressure perpendicular to the extending direction of the positive electrode from the outside of the battery case or container, the positive electrode and the separator is easily adhesively bonded.

The pressure is not particularly limited, but differs depending on the battery size, the number of electrode laminates or stacks, or the number of turns. For example, the pressure of 0.1 Pa or more may be maintained for 10 seconds or more.

The manufacturing process of the battery may be performed in a state of charge or a state of discharge of the battery.

The above-mentioned battery (non-aqueous electrolyte secondary battery) does not cause battery swelling when the battery is initially charged or left in a high temperature environment for a long time, and can suppress swelling of the positive electrode active material layer by the electrolyte solution even in a temperature environment of 60° C. or more, and can improve cycle life characteristics and output characteristics at a high temperature.

In addition, the alkali metal carbonate can be actively decomposed by overcharging. A battery provided with a pressure operated safety mechanism can be disconnected by overcharging for a short time, and can actively decompose alkali metal carbonate. In addition, the high temperature storage characteristics and productivity of the battery are also good.

Therefore, the nonaqueous electrolyte secondary battery using the binder for positive electrode of the present embodiment, taking advantage of the above characteristics can be widely applied to the same applications including information and communication devices such as mobile phones, smartphones, and tablet terminals, electric vehicles (EVs), plug-in hybrid vehicles (PHEV), hybrid vehicles (HEVs), vehicle-mounted power supplies such as idling-stop vehicles, home backup power supply, storage of natural energy, large power storage system such as load leveling, etc., as well as applications such as conventional non-aqueous electrolyte secondary battery is used.

### EXAMPLES

Hereinafter, the present embodiment will be described in detail based on Examples, but the following Examples are merely examples, and the present invention is not limited to the following Examples.

### [1. Material Preparation of Composite Binder]

Table 1 shows the materials (binder materials A-G) used to make the composite binder.

The binder material A is a liquid in which untreated cellulose nanofibers are dispersed in NMP. The binder material A was prepared by adding an equal volume or more of NMP to a liquid (a solid ratio of 5% by mass) in which untreated cellulose nanofibers were dispersed in water, evaporating water with stirring using a rotary evaporator (200 hPa, 70 to 90° C., 160 rpm), and then irradiating ultrasonic waves (frequency: 38 kHz, 1 minute). In the binder material A, when the solid ratio exceeds 7% by mass, aggregation and sedimentation tend to occur, so that the solid ratio was set to 4.4% by mass. Note that a liquid in which cellulose nanofibers were dispersed in water was prepared by adding a commercially available crystalline cellulose powder (manufactured by Asahi Kasei Chemicals Co., Ltd., registered trademark: CEOLUS FD-101, average particle diameter: 50 μm, bulk density: 0.3 g/cc) so that cellulose was 4% by mass based on the total amount of the aqueous dispersion, and then charging into a stone mill type defibration treatment apparatus and passing it between stone molars 10 times.

The binder material B is a liquid in which semi-esterified cellulose nanofibers are dispersed in NMP The method for producing the binder material B is the same as that of the binder material A except using a liquid (solid ratio: 5% by mass) in which semi-esterified cellulose nanofibers are dispersed in water. In the binder material B, when the solid ratio exceeds 10% by mass, aggregation and sedimentation tend to occur, so that the solid ratio was set to 4.1% by mass. Note that a liquid in which the semi-esterified cellulose nanofibers were dispersed in water was prepared by blending an untreated commercially available crystalline cellulose powder (manufactured by Asahi Kasei Chemicals Co., Ltd., registered trademark: CEOLUS FD-101, average particle diameter: 50 μm, bulk density: 0.3 g/cc) with succinic anhydride at a ratio of 86.5:13.5, followed by a reaction treatment in a container heated at 130° C., and then adding the cellulose to the total amount of the aqueous dispersion so that the cellulose became 4 wt %, and then charging the mixture into a stone mill type defibration treatment apparatus and passing the mixture between stone molars 10 times.

The binder material C is a liquid in which cellulose nanofibers subjected to a semi-esterification treatment of cellulose and addition of secondarily propylene oxide are dispersed in NMP. The method for producing the binder material C is the same as that of the binder material B except using a liquid (solid ratio: 5% by mass) in which cellulose nanofibers to which propylene oxide is secondarily added are dispersed in water after semi-esterification treatment of cellulose. In the binder material C, when the solid ratio exceeds 10%, aggregation and sedimentation tend to occur, so that the solid ratio was set to 3.3% by mass. Liquid in which a cellulose nanofiber with an added propylene oxide was distributed in water was prepared by blending unprocessed, commercially available, cellulose powder (manufactured by Asahi Kasei Chemicals Co., Ltd., registered trademark: CEOLUS FD-101, average particle size: 50 μm, bulk density: 0.3 g/cc) and succinic anhydride in a ratio of 86.5:13.5 and then performing a reaction process in a container heated at 130° C. Then, further, adding the propylene oxide to the cellulose weight so as to be 4.5 wt %, performing a reaction process at 140° C., and adding the cellulose to the total amount of the water variant so as to be 4 wt %, and feeding the cellulose into the lithic defibration processor and passing it between stone molars by 10 times.

The binder material D is a liquid in which cellulose nanofibers containing lignin obtained from hardwood are dispersed in NMP. The method for producing the binder material D is the same as that of the binder material A except using a liquid in which cellulose nanofibers containing lignin obtained from hardwood are dispersed in water. In the binder material D, when the solid ratio exceeds 2% by mass, aggregation and sedimentation tend to occur, so that the solid ratio is set to 1.5% by mass. Note that a liquid in which cellulose nanofibers containing lignin obtained from hardwood were dispersed in water was prepared by performing a treatment in which cellulose was added so as to have 4 wt % with respect to the total amount of the aqueous dispersion, and then charged into a stone mill type defibration treatment apparatus and passed between stone molars 10 times.

The binder material E is a liquid in which cellulose nanofibers containing lignin obtained from softwood are dispersed in NMP. The method for producing the binder material E is similar to that of the binder material A except using cellulose nanofibers generated from softwood. In the binder material E, when the solid content ratio exceeds 2% by mass, aggregation and sedimentation tend to occur, so that the solid ratio is set to 1.3% by mass. Note that a liquid in which a cellulose nanofiber containing lignin obtained from a softwood was dispersed in water was prepared by performing a treatment in which cellulose was added to a total amount of an aqueous dispersion so that cellulose was 4 wt % and charged into a stone mill type defibration treatment apparatus and passed between stone molars 10 times.

The binder material F is a liquid in which nanoclays (4% dispersed liquid viscosity 4000 mPa·s: manufactured by SUMECTON-SAN, Kunimine Industries) are dispersed in NMPs. In the binder material F, when the solid content ratio exceeded 4% by mass, foaming was vigorous, so that the solid ratio was set to 1.9% by mass.

A method for producing a binder material F was prepared by adding an equal volume or more of NMP to a liquid (solid ratio: 4% by mass) in which nanoclay was dispersed in water, evaporating water with stirring using a rotary evaporator (200 hPa, 70 to 90° C., 160 rpm), and then irradiating an ultrasonic wave (frequency: 38 kHz, 1 minute).

The binder material G is a liquid in which PVdF is dissolved in NMP, and was produced by mixing NMP and PVdF (mass-average molecular weight: 280000) by a planetary centrifugal mixer (manufactured by Thinky Corporation, 2000 rpm, 30 minutes). The binder material G was set to a solid ratio of 12% by mass.

TABLE 1

| BINDER MATERIAL | KIND OF BINDER MATERIAL |
|---|---|
| BINDER MATERIAL A | CELLULOSE NANOFIBER (UNTREATED) |
| BINDER MATERIAL B | CELLULOSE NANOFIBER (SA) |
| BINDER MATERIAL C | CELLULOSE NANOFIBER (AFTER SA, |
| | ADD PO) |
| BINDER MATERIAL D | CELLULOSE NANOFIBER (HARDWOOD) |
| BINDER MATERIAL E | CELLULOSE NANOFIBER (SOFTWOOD) |
| BINDER MATERIAL F | NANOCLAY |
| BINDER MATERIAL G | PVdF |

TABLE 2

| | | | | ASPECT RATIO | |
|---|---|---|---|---|---|
| | KIND OF | | | (LENGTH/ | |
| | DISPERSED | DIAMETER OF | LENGTH OF | DIAMETER | |
| BINDER MATERIAL | MATERIAL | FIBER (nm) | FIBER (um) | OF FIBER) | LIGNIN |
| BINDER MATERIAL A | UNTREATED | 50~200 | 1~1000 | 5~100000 | × |
| BINDER MATERIAL B | SA TREATMENT | 50~200 | 1~1000 | 5~100000 | × |
| BINDER MATERIAL C | AFTER SA ADD PO | 50~200 | 1~1000 | 5~100000 | × |
| BINDER MATERIAL D | HARDWOOD | 700~1200 | 1~4000 | 0.8~5700 | ○ |
| BINDER MATERIAL E | SOFTWOOD | 700~1200 | 1~4000 | 0.8~5700 | ○ |

### [2. Preparation of Binder]

As the electrode binder, using the binder materials A to G, so as to have a predetermined solid composition shown in Table 3 below, a composite binder containing NMP as a binder solvent by a planetary centrifugal mixer (manufactured by Thinky Corporation, “Rentaro”, 2000 rpm, 30 minutes) was prepared.

TABLE 3

| | COMPOSITION RATIO OF BINDER MATERIAL (SOLID MASS RATIO) | | | | | | |
|---|---|---|---|---|---|---|---|
| | BINDER | BINDER | BINDER | BINDER | BINDER | BINDER | BINDER |
| ELECTRODE | MATERIAL | MATERIAL | MATERIAL | MATERIAL | MATERIAL | MATERIAL | MATERIAL |
| BINDER | A | B | C | D | E | F | G |
| BINDER 1 | 25 | — | — | — | — | — | 75 |
| BINDER 2 | 50 | — | — | — | — | — | 50 |
| BINDER 3 | 75 | — | — | — | — | — | 25 |
| BINDER 4 | 100 | — | — | — | — | — | — |
| BINDER 5 | — | 25 | — | — | — | — | 75 |
| BINDER 6 | — | 50 | — | — | — | — | 50 |
| BINDER 7 | — | 75 | — | — | — | — | 25 |
| BINDER 8 | — | 100 | — | — | — | — | — |
| BINDER 9 | — | — | 25 | — | — | — | 75 |
| BINDER 10 | — | — | 50 | — | — | — | 50 |
| BINDER 11 | — | — | 75 | — | — | — | 25 |
| BINDER 12 | — | — | 100 | — | — | — | — |
| BINDER 13 | — | — | — | 25 | — | — | 75 |
| BINDER 14 | — | — | — | 50 | — | — | 50 |
| BINDER 15 | — | — | — | 75 | — | — | 25 |
| BINDER 16 | — | — | — | 100 | — | — | — |
| BINDER 17 | — | — | — | — | 25 | — | 75 |
| BINDER 18 | — | — | — | — | 50 | — | 50 |
| BINDER 19 | — | — | — | — | 75 | — | 25 |
| BINDER 20 | — | — | — | — | 100 | — | — |
| BINDER 21 | — | — | — | — | — | 25 | 75 |
| BINDER 22 | — | — | — | — | — | 50 | 50 |
| BINDER 23 | — | — | — | — | — | 75 | 25 |
| BINDER 24 | — | — | — | — | — | 100 | — |
| BINDER 25 | — | — | — | — | — | — | 100 |

### [3. Slurry and Electrode Preparation]

### <Investigation on Agglomeration and Sedimentation of Slurry>

This test confirms the characteristics of slurry in terms of agglomeration and sedimentation.

The NCA electrode slurry was mixed with NCA (LiNi_{0.8}Co_{0.15}Al_{0.05}O₂) as an active material, acetylene black as a conduction aid, and a predetermined electrode binder shown in Table 4 so as to have a solid ratio of 94:2:4% by weight, and was kneaded and slurried using a planetary centrifugal mixer (manufactured by Thinky Corporation, “Rentaro”, 2000 rpm, 15 minutes).

As shown in Table 4, after observing the aggregation state, the sedimentation state, and the foaming state of the slurry, the aluminum current collector having a thickness of 20 μm was coated using a doctor blade, and the coating property of the slurry was observed.

As is apparent from Table 4, it can be seen that the cellulose nanofibers contained in the binder are preferably a slurry using a cellulose nanofiber which has been subjected to a polybasic acid half ester (SA) treatment or further subjected to a propylene oxide addition treatment as a secondary treatment, rather than an untreated one. Note that ethylene oxide may be subjected to an addition treatment instead of propylene oxide. In addition, as an overall tendency, as the content of PVdF increases, the agglomeration tends to be improved, and as for the coatability, it can be seen to come close to the slurry of only PVdF.

TABLE 4

| | COMPOSITION OF | | | | | | |
|---|---|---|---|---|---|---|---|
| | ELECTRODE BINDER | AGGREGATION | SEDIMENTATION | FOAMING | | | |
| SLURRY | (SOLID MASS RATIO) | STATE | STATE | STATE | FLUIDITY | COATABILITY | ADHESIVENESS |
| SLURRY 1 | UNTREATED = 100 | X | Δ | ◯ | Δ | X | Δ |
| SLURRY 2 | UNTREATED/PVdF = 75/25 | X | ◯ | ⊚ | ◯ | Δ | ◯ |
| SLURRY 3 | UNTREATED/PVdF = 50/50 | Δ | ◯ | ⊚ | ◯ | ◯ | ◯ |
| SLURRY 4 | UNTREATED/PVdF = 25/75 | ◯ | ◯ | ⊚ | ◯ | ◯ | ◯ |
| SLURRY 5 | SA = 100 | ◯ | ◯ | ◯ | ⊚ | ⊚ | ◯ |
| SLURRY 6 | SA/PVdF = 75/25 | ⊚ | ⊚ | ⊚ | ⊚ | ⊚ | ⊚ |
| SLURRY 7 | SA/PVdF = 50/50 | ⊚ | ⊚ | ⊚ | ⊚ | ⊚ | ⊚ |
| SLURRY 8 | SA/PVdF = 25/75 | ⊚ | ⊚ | ⊚ | ⊚ | ⊚ | ⊚ |
| SLURRY 9 | ADD SAPO = 100 | ◯ | ◯ | ◯ | ⊚ | ◯ | ◯ |
| SLURRY 10 | ADD SAPO/PVdF = 75/25 | ⊚ | ⊚ | ⊚ | ⊚ | ◯ | ⊚ |
| SLURRY 11 | ADD SAPO/PVdF = 50/50 | ⊚ | ⊚ | ⊚ | ⊚ | ⊚ | ⊚ |
| SLURRY 12 | ADD SAPO/PVdF = 25/75 | ⊚ | ⊚ | ⊚ | ◯ | ⊚ | ⊚ |
| SLURRY 13 | HARDWOOD = 100 | X | X | ◯ | ◯ | X | ◯ |
| SLURRY 14 | HARDWOOD/PVdF = 75/25 | X | Δ | ⊚ | ◯ | X | ⊚ |
| SLURRY 15 | HARDWOOD/PVdF = 50/50 | X | ◯ | ⊚ | ◯ | X | ⊚ |
| SLURRY 16 | HARDWOOD/PVdF = 25/75 | Δ | ◯ | ⊚ | ◯ | Δ | ⊚ |
| SLURRY 17 | SOFTWOOD = 100 | X | X | ◯ | ◯ | X | ◯ |
| SLURRY 18 | SOFTWOOD/PVdF = 75/25 | X | Δ | ⊚ | ◯ | X | ⊚ |
| SLURRY 19 | SOFTWOOD/PVdF = 50/50 | X | ◯ | ⊚ | ◯ | X | ⊚ |
| SLURRY 20 | SOFTWOOD/PVdF = 25/75 | Δ | ◯ | ⊚ | ◯ | Δ | ⊚ |
| SLURRY 21 | NANOCLAY = 100 | ⊚ | ⊚ | X | ⊚ | X | X |
| SLURRY 22 | NANOCLAY/PVdF = 75/25 | ⊚ | ⊚ | ◯ | ⊚ | X | X |
| SLURRY 23 | NANOCLAY/PVdF = 50/50 | ⊚ | ⊚ | ◯ | ◯ | X | Δ |
| SLURRY 24 | NANOCLAY/PVdF = 25/75 | ⊚ | ⊚ | ◯ | ◯ | Δ | Δ |
| SLURRY 25 | PVdF = 100 | ⊚ | ⊚ | ⊚ | X | ⊚ | Δ |

AGGREGATION STATE: ⊚NONEXISTENT, ◯HARDLY AGGREGATE, ΔEASILY AGGREGATE, X QUICKLY AGGREGATE
SEDIMENTATION STATE: ⊚ NONEXISTENT, ◯HARDLY SEDIMENT, ΔEASILY SEDIMENT, X QUICKLY SEDIMENT
FOAMING STATE: ⊚ NONEXISTENT, ◯SMALL BUBBLES, X MANY SMALL AIR BUBBLES
FLUIDITY: ⊚VERY GOOD, ◯GOOD, X NO FLUIDITY (GELATION)
COATABLITY: ⊚VERY GOOD, ◯GOOD, ΔLITTLE UNEVENNESS, X LARGE UNEVENNESS
ADHESIVENESS: ⊚VERY GOOD, ◯GOOD, X TENDS TO PEEL OFF FROM CURRENT COLLECTOR

### <Fabrication of NCA Electrodes>

Test electrodes 1 to 25 were prepared by coating each of the slurries shown in Table 4 (slurries 1 to 25) on an aluminum foil having a thickness of 20 μm using an applicator, preliminarily drying it at 80° C., rolling it by a roll press, and drying it under reduced pressure (160° C., 12 hours). The capacitive densities of the respective NCA-positive electrodes were 2.1 mAh/cm². However, since the solid content of the slurries of the test electrode 13, the test electrode 17, and the test electrode 21 became too low, electrodes having capacitive densities exceeding 1 mAh/cm² could not be produced. From this result, it can be seen that the solid ratio of the binder material is preferably 2% by mass or more in CeNF system.

### <Preparation of NCM523 Electrodes>

The test elements 26 to 29 were produced by blending NCM (LiNi_{0.5}Co_{0.2}Mn_{0.3}O₂) as an active material, assembler black as an active material, a predetermined element binder shown in Table 5 as an element binder to a solid ratio of 94:2:4% by mass, using a planetary centrifugal mixer (Thinky Corporation, “Rentaro”, 2000 rpm, 15 minutes) to blend and slurry, and applying it on an aluminum foil having a thickness of 20 μm using an applicator, temporarily dry at 80° C., then rolling by a roll press, and dry under reduced pressure (160° C., 12 hours). The capacitive densities of the respective NCM523 positive electrodes were 2.5 mAh/cm².

TABLE 5

| | COMPOSITION OF ELECTRODE BINDER |
|---|---|
| TEST ELECTRODE | (SOLID MASS RATIO) |
| TEST ELECTRODE 26 | UNTREATED = 100 |
| TEST ELECTRODE 27 | UNTREATED/PVdF = 75/25 |
| TEST ELECTRODE 28 | UNT REATED/PVdF = 50/50 |
| TEST ELECTRODE 29 | PVdF = 100 |

### [4. Preparation of all NCA/Si Batteries]

NCA/Si total batteries of Examples 1-14, Reference Examples 1-6 and Comparative Example 1 are test batteries with the test electrodes shown in Table 6. A CR2032 type coin cell was manufactured using an NCA electrode (test electrode) as a positive electrode, a Si electrode as a negative electrode, a glass nonwoven fabric (GA-100) as a separator, and a 1 mol/L LiPF₆ (EC:DEC=50:50 vol %+VC1 wt %) as an electrolyte for the test battery.

Si electrodes were prepared by mixing Si, PVdF (mass-average molecular weight: 280,000), and acetylene black in a solid ratio of 94:2:4% by mass, kneading them using a planetary centrifugal mixer (manufactured by Thinky Corporation, “Rentaro”, 2000 rpm, 15 minutes), coating the slurried stainless steel foil with a thickness of 8 μm, provisionally drying the stainless steel foil at 100° C., applying an alkali metal silicate aqueous solution (A₂O-nSiO₂; n=3.2, A=Li,Na,K) using a gravure coater, and drying under reduced pressure (160° C., 12 hours). The capacitance densities of the Si electrodes were 4.5 mAh/cm². Here, the reason why the alkali metal silicate aqueous solution was applied to the Si electrode was to extend the life of the Si electrode, as described in Patent Document 7, and the test battery was used to improve the high temperature durability so that the rate is not controlled by the characteristics of the Si negative electrode.

In the present invention, full battery is a battery evaluated without using metallic lithium as the counter electrode. Incidentally, the semi-battery means a battery using a metal lithium on the counter electrode.

TABLE 6

| | | COMPOSITION OF |
|---|---|---|
| | | ELECTRODE BINDER |
| TEST BATTERY | TEST ELECTRODE | (SOLID MASS RATIO) |
| REFERENCE | TEST | UNTREATED = 100 |
| EXAMPLE 1 | ELECTRODE 1 | |
| EXAMPLE 1 | TEST | UNTREATED/PVdF = |
| | ELECTRODE 2 | 75/25 |
| EXAMPLE 2 | TEST | UNTREATED/PVdF = |
| | ELECTRODE 4 | 25/75 |
| REFERENCE | TEST | SA = 100 |
| EXAMPLE 2 | ELECTRODE 5 | |
| EXAMPLE 3 | TEST | SA/PVdF = 75/25 |
| | ELECTRODE 6 | |
| EXAMPLE 4 | TEST | SA/PVdF = 50/50 |
| | ELECTRODE 7 | |
| EXAMPLE 5 | TEST | SA/PVdF = 25/75 |
| | ELECTRODE 8 | |
| REFERENCE | TEST | ADD SAPO = 100 |
| EXAMPLE 3 | ELECTRODE 9 | |
| EXAMPLE 6 | TEST | ADD SAPO/PVdF = |
| | ELECTRODE 10 | 75/25 |
| EXAMPLE 7 | TEST | ADD SAPO/PVdF = |
| | ELECTRODE 11 | 50/50 |
| EXAMPLE 8 | TEST | ADD SAPO/PVdF = |
| | ELECTRODE 12 | 25/75 |
| EXAMPLE 9 | TEST | HARDWOOD/PVdF = |
| | ELECTRODE 14 | 75/25 |
| EXAMPLE 10 | TEST | HARDWOOD/PVdF = |
| | ELECTRODE 15 | 50/50 |
| EXAMPLE 11 | TEST | HARDWOOD/PVdF = |
| | ELECTRODE 16 | 25/75 |
| EXAMPLE 12 | TEST | SOFTWOOD/PVdF = |
| | ELECTRODE 18 | 75/25 |
| EXAMPLE 13 | TEST | SOFTWOOD/PVdF = |
| | ELECTRODE 19 | 50/50 |
| EXAMPLE 14 | TEST | SOFTWOOD/PVdF = |
| | ELECTRODE 20 | 25/75 |
| REFERENCE | TEST | NANOCLAY/PVdF = |
| EXAMPLE 4 | ELECTRODE 22 | 75/25 |
| REFERENCE | TEST | NANOCLAY/PVdF = |
| EXAMPLE 5 | ELECTRODE 23 | 50/50 |
| REFERENCE | TEST | NANOCLAY/PVdF = |
| EXAMPLE 6 | ELECTRODE 24 | 25/75 |
| COMPARATIVE | TEST | PVdF = 100 |
| EXAMPLE 1 | ELECTRODE 25 | |

### <Cycle Life Characteristics in 60° C. Environment>

This test is a test for evaluating the cycle life characteristics at 60° C. environment of the test battery of Examples 1-14, Reference Examples 1-6 and Comparative Example 1.

In the charge-discharge test, after charging and discharging at each rate of 0.1C-rate, 0.2C-rate, 0.5C-rate, 1C-rate rates for one cycle at ambient temperatures of 60° C. and cutoff potentials of 4.25-2.7V, charging and discharging were repeated at 3C-rate.

Incidentally, the charging and discharging rate is an index based on a standard in which the battery having a capacity of the nominal capacity value is discharged by constant current discharge, and the current value to be a complete discharge in one hour is made as “1C-rate”, for example, the current value to be a complete discharge in 5 hours is noted as “0.2C-rate”, the current value to be a complete discharge in 10 hours is noted as “0.1C-rate”.

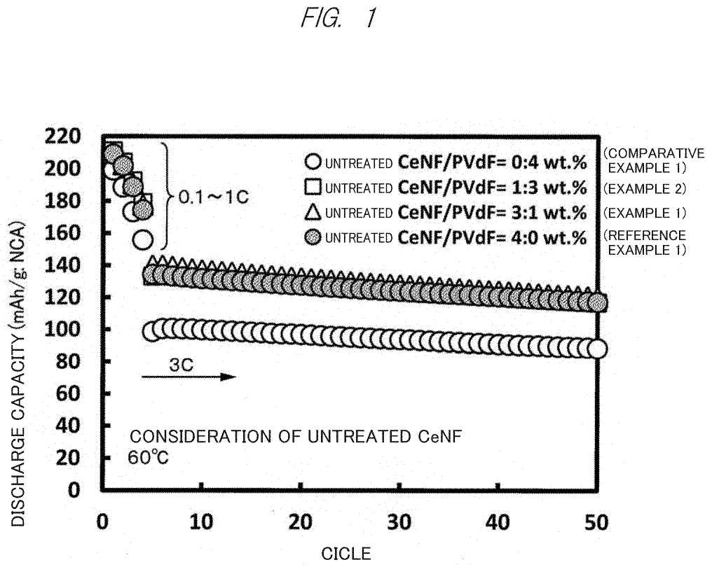

FIG. 1 is a graph showing a comparison between a battery (Example 1, Example 2, Reference Example 1) having an electrode containing a binder material A as an electrode binder and a battery (Comparative Example 1) having an electrode using only a binder material G as an electrode binder.

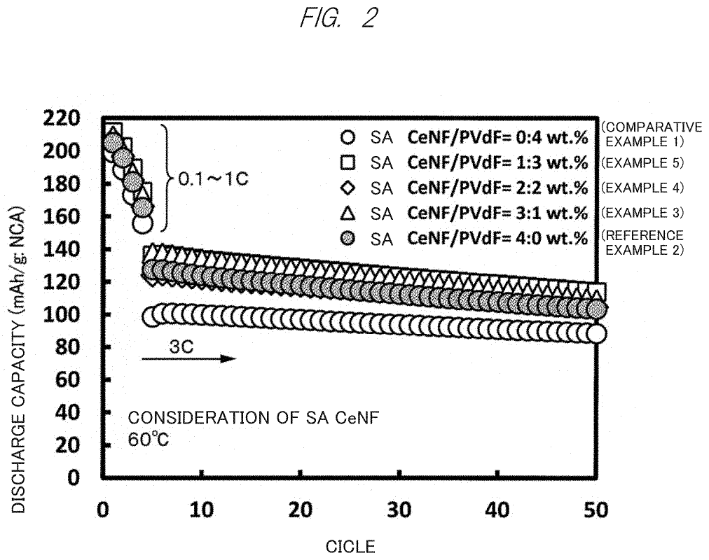

FIG. 2 is a graph showing a comparison between a battery having an electrode containing the binder material B as an electrode binder (Examples 3 to 5, Reference Example 2) and a battery having an electrode using only the binder material G as an electrode binder (Comparative Example 1).

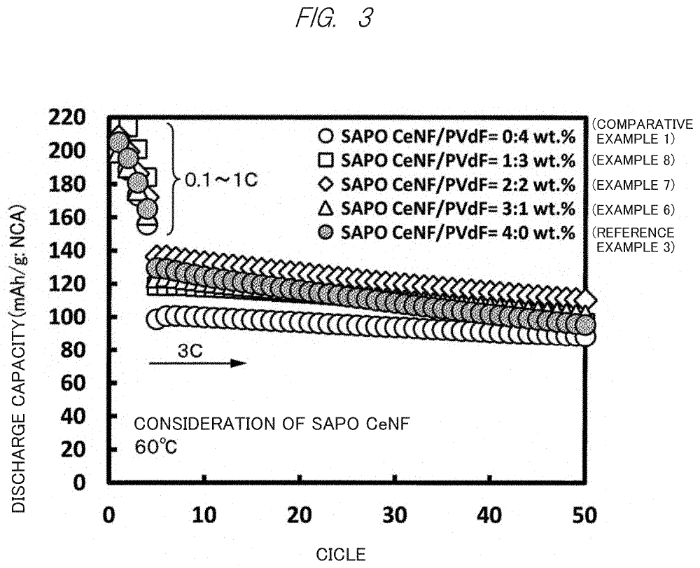

FIG. 3 is a graph showing a comparison between a battery having an electrode containing the binder material C as an electrode binder (Examples 6 to 8, Reference Example 3) and a battery having an electrode using only the binder material G as an electrode binder (Comparative Example 1).

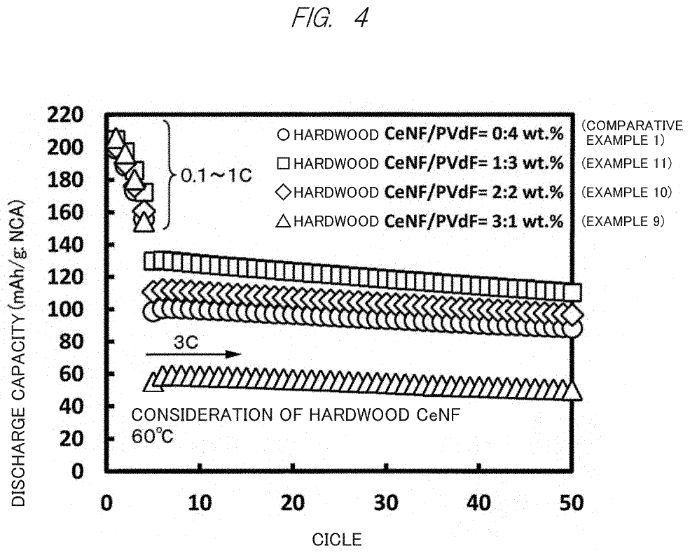

FIG. 4 is a graph showing a comparison between a battery (Examples 9 to 11) having an electrode containing the binder material D as an electrode binder and a battery (Comparative Example 1) having an electrode using only the binder material G as an electrode binder.

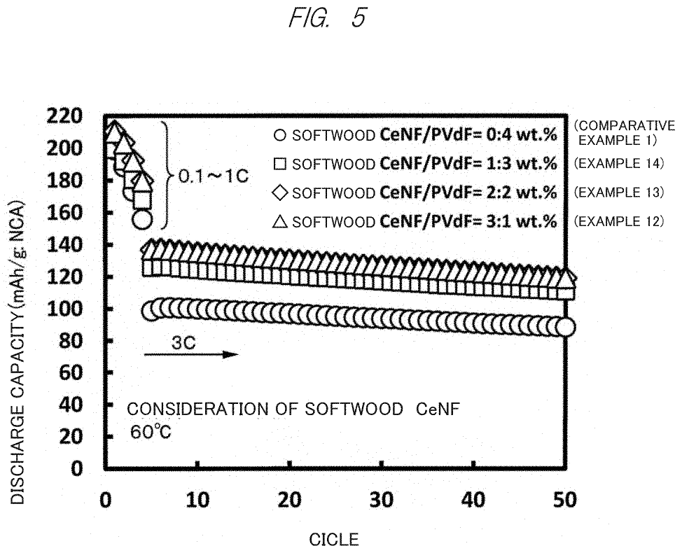

FIG. 5 is a graph showing a comparison of a battery (Examples 12 to 14) having an electrode including the binder material E as an electrode binder and a battery (Comparative Example 1) having an electrode using only the binder material G as an electrode binder.

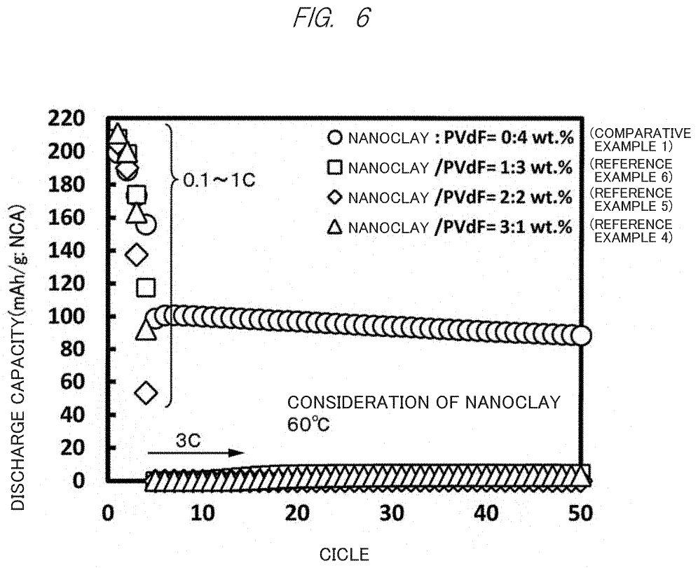

FIG. 6 is a graph showing a comparison between a battery having an electrode including the binder material F as an electrode binder (Reference Examples 4 to 6) and a battery including an electrode using only the binder material G as an electrode binder (Comparative Example 1).

As is apparent from FIGS. 1 to 6, it can be seen that the battery containing any one of the binder materials A to E in the electrode binder (Examples 1 to 14) is clearly improved in the cycle life characteristics (in particular, the characteristics in charge and discharge after 5 cycles) as compared with the battery composed only of the binder material G as the electrode binder (Comparative Example 1). On the other hand, even in the case of the same nano-order particles, the battery containing the binder material F in the electrode binder (Reference Examples 4 to 6) had no effect of improving the life, and rather, result in that the performance became deteriorated. From these results, it was found that the inclusion of cellulose nanofibers in the electrode binder has an effect of improving the cycle life characteristics of the battery at a high temperature.

### <Cycle Life Characteristics in 80° C. Environment>

This test is a test for evaluating the cycle life characteristics at 80° C. environment of the test battery of Examples 1-14, Reference Examples 1-6 and Comparative Example 1.

In the charge-discharge test, after charging and discharging at each rate of 0.1C-rate, 0.2C-rate, 0.5C-rate, 1C-rate rates for one cycle at ambient temperatures of 80° C. and cut-off potentials of 4.25-2.7V, charging and discharging were repeated with 3C-rate.

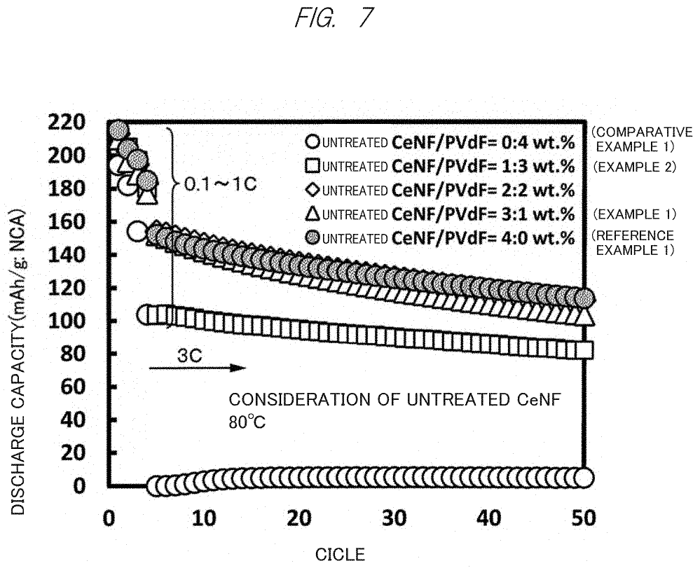

FIG. 7 is a graph showing a comparison between a battery (Example 1, Example 2, Reference Example 1) having an electrode containing the binder material A as an electrode binder and a battery (Comparative Example 1) having an electrode using only the binder material G as an electrode binder.

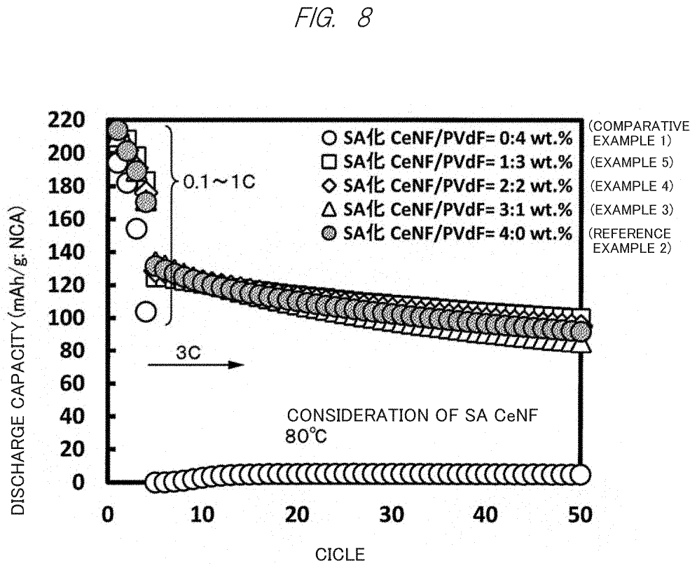

FIG. 8 is a graph showing a comparison between a battery having an electrode containing the binder material B as an electrode binder (Examples 3 to 5, Reference Example 2) and a battery having an electrode using only the binder material G as an electrode binder (Comparative Example 1).

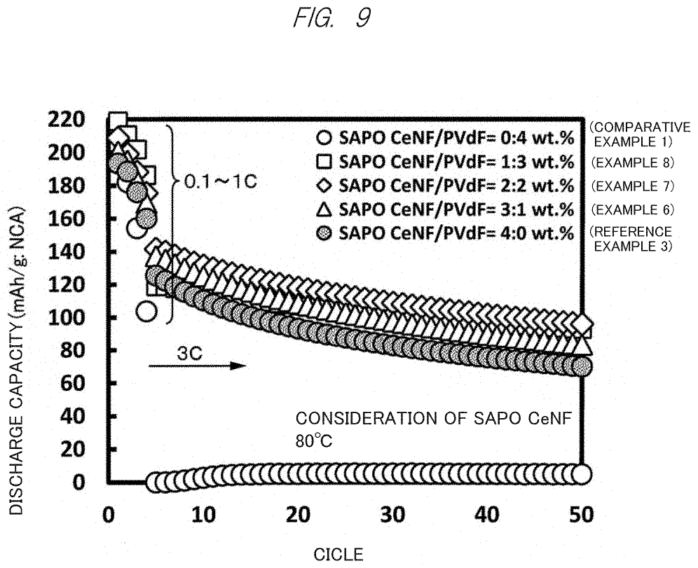

FIG. 9 is a graph showing a comparison between a battery having an electrode containing the binder material C as an electrode binder (Examples 6 to 8, Reference Example 3) and a battery having an electrode using only the binder material G as an electrode binder (Comparative Example 1).

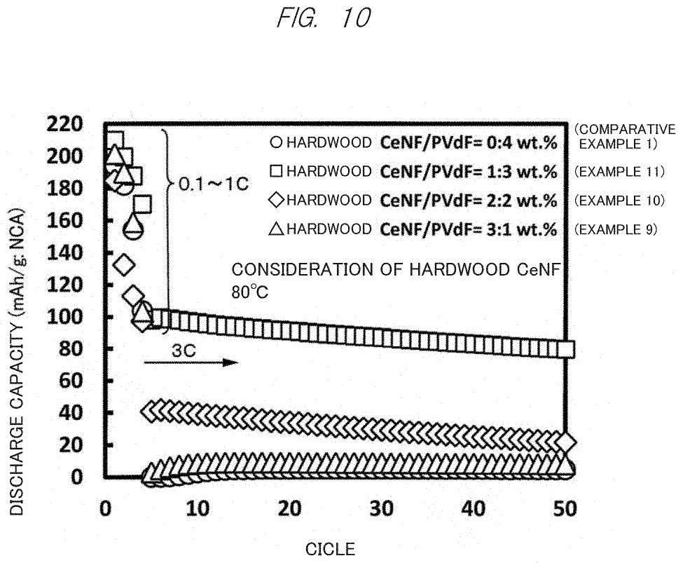

FIG. 10 is a graph showing a comparison between a battery (Examples 9 to 11) having an electrode containing the binder material D as an electrode binder and a battery (Comparative Example 1) having an electrode using only the binder material G as an electrode binder.

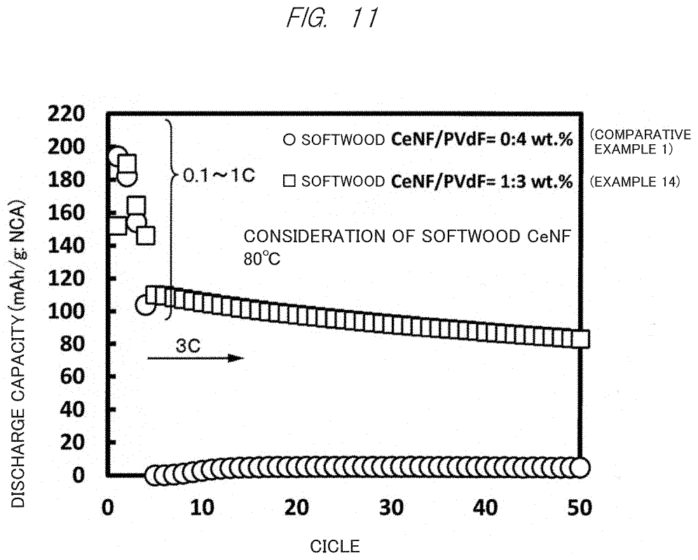

FIG. 11 is a graph showing a comparison between a battery (Example 14) having an electrode including the binder material E as an electrode binder and a battery (Comparative Example 1) having an electrode using only the binder material G as an electrode binder.

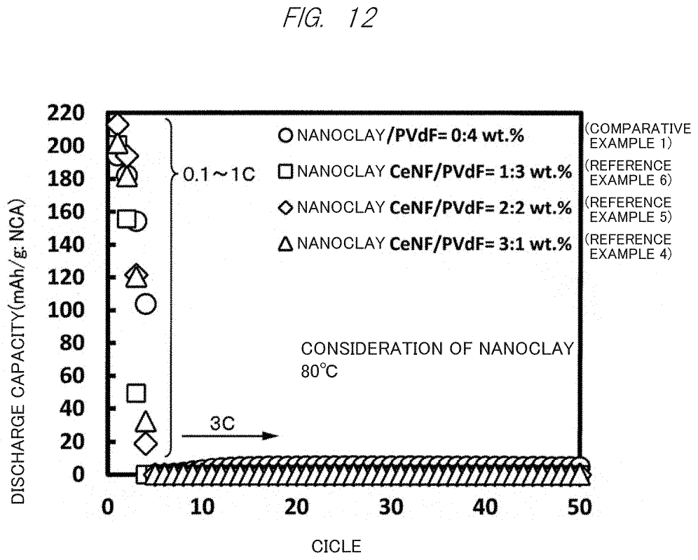

FIG. 12 is a graph showing a comparison between a battery having an electrode containing the binder material F as an electrode binder (Reference Examples 4 to 6) and a battery having an electrode using only the binder material G as an electrode binder (Comparative Example 1).

As is apparent from FIGS. 7 to 12, the battery containing any of the binder materials A to E in the electrode binder (Examples 1 to 14) clearly has improved cycle life characteristics as compared with the battery composed of only the binder material G as the electrode binder (Comparative Example 1). On the other hand, even in the case of the same nano-order particles, the battery containing the binder material F in the electrode binder (reference examples 4 to 6) has no effect of improving the life. From these results, it was found that the inclusion of cellulose nanofibers in the electrode binder has an effect of improving the cycle life characteristics of the battery at a high temperature. In particular, batteries containing any of the binder materials A-C in the electrode binder (Examples 1-8, Reference Examples 1-3) showed particularly significant differences.

In an environment of 80° C., as the number of cellulose nanofibers contained in the binder of the test electrode increases, the cycle life characteristic at a high temperature tends to be improved, but the slope of the graph tends to be steep, and the output characteristic tends to be lowered.

From the discharge capacity immediately after aging and 150 cycles, the reduction rate of the battery capacity was calculated. The reduction rate of the battery capacities was 52% when untreated CeNF was used and 42% when SA-treated CeNF was used. Therefore, it was confirmed that the cycling property was improved in the binder to which the SAylation treatment CeNF was added, regardless of the added quantity. From the above, it was confirmed that the cycling characteristics in high temperature environments can be improved by adding a small amount of SA-treated CeNF of about 1 wt % to PVdF. It is considered that this is because CeNF is hydrophobized by the SA treatment, so that the affinity with PVdF which is hydrophobic is improved, and therefore, the property is improved by suppressing the swelling of PVdF in the electrolytic solution at a high temperature. In addition, although a prototype of NCA positive electrode was carried out using this binder under an environment of ordinary temperature and normal pressure, a positive electrode slurry having fluidity was successfully obtained without gelation. Originally, moisture and the like in the atmosphere are caused, and the pH value of the positive electrode active material increases. However, it is considered that, at this time, a CeNF subjected to an SA treatment is used, and this acts as a neutralizing agent of an inclusion type, thereby suppressing an increase in pH value of the positive electrode active material and preventing gelation of the binder.

### [5. Preparation of all NCM523/SiO Batteries]

NCM523 of the electrodes of Example 15, Example 16, Reference Example 7 and Comparative Example 2 is a test battery provided with an electrode binder shown in Table 7 A CR2032 type coin cell was manufactured using a NCM523 electrode (test electrode) as a positive electrode, a SiO electrode as a negative electrode, a polyolefin microporous membrane (PP/PE/PP) as a separator, and 1 mol/L LiPF₆ (EC:DEC=50:50 vol %) as an electrolyte for the test battery.

SiO electrode was prepared by blending SiO, PVA (degree of polymerization 2800), acetylene black, and VGCF in a solid ratio so as to be 85:10:4:1% by mass, kneading them using a planetary centrifugal mixer (manufactured by Thinky Corporation, “Rentaro”, 2000 rpm, 15 minutes), coating the slurried material on a copper foil having a thickness of 40 μm, temporarily drying at 80° C., and then drying under reduced pressure (160° C., 12 hours). The capacitance densities of the SiO electrodes were 3.2 mAh/cm². Incidentally, the SiO electrode, before assembling the entire battery, to prepare a half-battery using metallic lithium in advance as the counter electrode, after canceling the irreversible capacity, using the SiO electrode obtained by disassembling the half-battery.

TABLE 7

| | | COMPOSITION OF |
|---|---|---|
| | | ELECTRODE BINDER |
| TEST BATTERY | TEST ELECTRODE | (SOLID MASS RATIO) |
| REFERENCE | TEST | UNTREATED = 100 |
| EXAMPLE 7 | ELECTRODE 26 | |
| EXAMPLE 15 | TEST | UNTREATED/PVdF = |
| | ELECTRODE 27 | 75/25 |
| EXAMPLE 16 | TEST | UNTREATED/PVdF = |
| | ELECTRODE 28 | 50/50 |
| COMPARATIVE | TEST | PVdF = 100 |
| EXAMPLE 2 | ELECTRODE 29 | |

### <Cycle Life Characteristics in 30° C. Environment>

This test is a test to evaluate the cycle life characteristics at 30° C. environment of the test battery of Example 15, Example 16, Reference Example 7 and Comparative Example 2.

In the charge-discharge test, charge-discharge was repeated at 0.2C-rate under the condition of environmental temperatures of 30° C. and cut-off potentials of 4.3-2.5V.

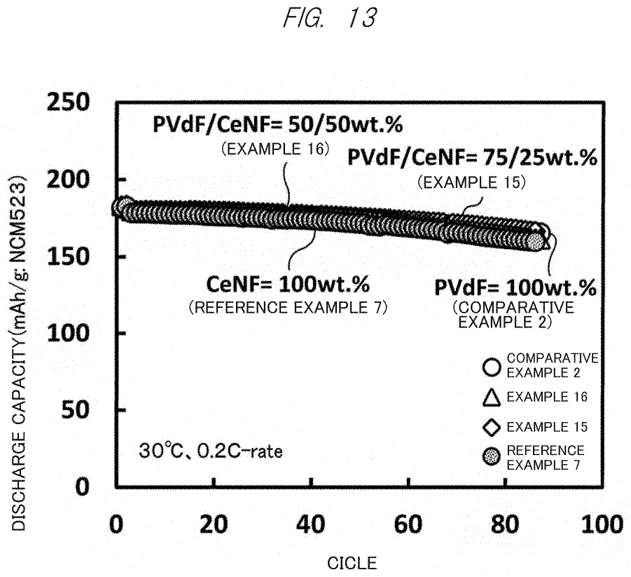

FIG. 13 is a graph showing a comparison between a battery having an electrode including a binder material A as an electrode binder (Example 15, Example 16, Reference Example 7), and a battery having an electrode using only the binder material G as an electrode binder (Comparative Example 2).

As is apparent from FIG. 13, in the 30° C. environment, there is no large difference in cycle life characteristics.

### <Cycle Life Characteristics in 60° C. Environment>

This test is a test to evaluate the cycle life characteristics at 60° C. environment of the test battery of Example 15, Example 16, Reference Example 7 and Comparative Example 2.

In the charge-discharge test, charge-discharge was repeated at 0.2C-rate under the condition of environmental temperatures of 60° C. and cut-off potentials of 4.3-2.5V.

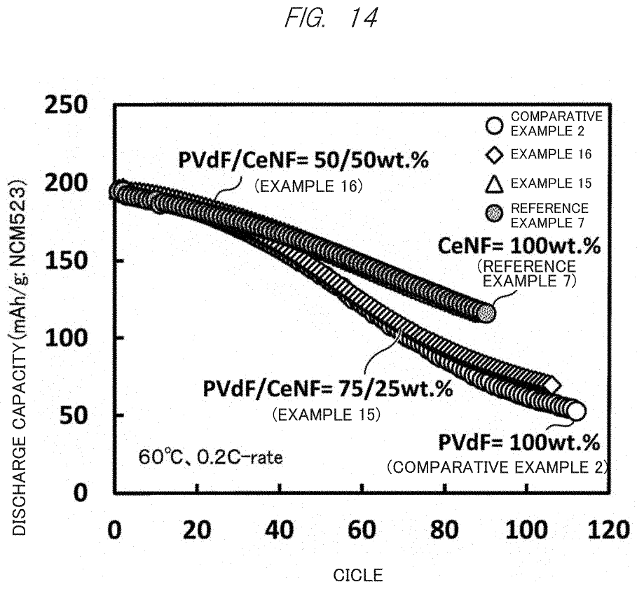

FIG. 14 is a graph showing a comparison between a battery having an electrode including a binder material A as an electrode binder (Example 15, Example 16, Reference Example 7), and a battery having an electrode using only the binder material G as an electrode binder (Comparative Example 2).

As is apparent from FIG. 14, in a 60° C. environment, by including the binder material A, the cycle life characteristics are improved. In particular, relating to the ratio of the binder material A and the binder material G, the effect increases as the ratio of the binder material A increases.

### [6. Confirmation of Gelation Resistance]

This test confirms whether the binder is strongly alkaline and gelates.

### (Gelation Resistance Test 1)

In the gelation resistance test 1, 2% by mass of lithium hydroxide (LiOH) was added to the binder 4, and the mixture was stirred using a planetary centrifugal mixer (manufactured by Thinky Corporation, “Rentaro”, 2000 rpm, 15 minutes), and then left for 12 hours at 25° C. environment.

### (Gelation Resistance Test 2)

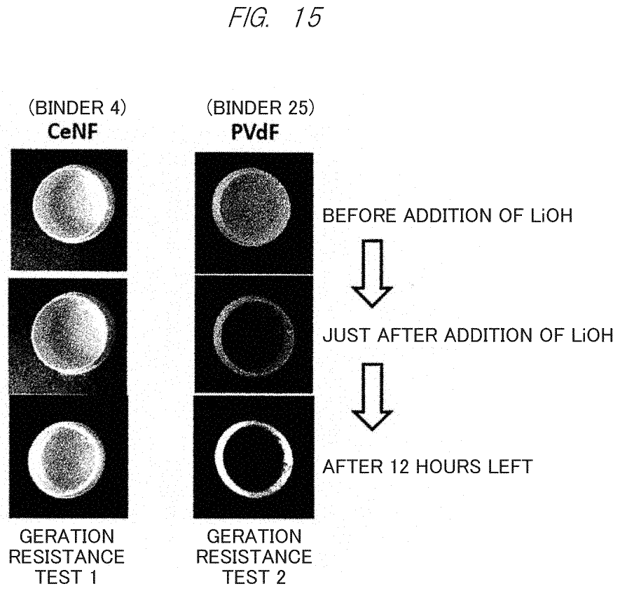

In the gelation resistance test 2, 2% by mass of lithium hydroxide (LiOH) was added to the binder 25, and the mixture was stirred using a planetary centrifugal mixer (manufactured by Thinky Corporation, “Rentaro”, 2000 rpm, 15 minutes), and then left for 12 hours at 25° C. environment. FIG. 15 shows the results of confirming the gelation resistance of the binder. As is apparent from FIG. 15, in the gelation resistance test 2, after adding LiOH, a change in color immediately occurred, whereas in the gelation resistance test 1, no change in color is observed even when left for 12 hours. In addition, in the gelation resistance test 2, after 12 hours of left, PVdF has gelated and changed into a gummy material, whereas in the gelation resistance test 1, the fluidity of the binder has not lost.

### [7. Preparation of Surface Coated Separator]

The test separators 1 to 4 were prepared by using a binder 5 and alumina (particle size: 200 nm) so as to have a predetermined solid composition shown in Table 8, kneading them by a planetary centrifugal mixer (manufactured by Thinky Corporation, “Rentaro”, 2000 rpm, 30 minutes), slurrying them into a polypropylene (PP) microporous film having a thickness of 16 μm, coating them on one side, temporarily drying them at 70° C., and then drying them under reduced pressure (80° C., 24 hours). The thickness of each of the surface coating layers of the test separators 1 to 4 was 4 μm. As a comparative example, an uncoated PP microporous film was used as the test separator

The test batteries of Example 17, Example 18, Example 19, Example 20, and Comparative Example 3 were test batteries with separators 1-5 shown in Table 8. The test battery (NCM111/graphite-total battery) was fabricated by assembling a CR2032 type coin cell using a NCM111 electrode as a positive electrode, a graphite electrode as a negative electrode, test separators 1 to 5 as separators, and 1 mol per L LiPF6 (EC:DEC=50:50 vol %) as an electrolyte, and left the coin cell to stand at 80° C. environment for 1 hour. The coating layer of the separator was provided on the positive electrode side.

NCM111 electrode was prepared by blending NCM111, PVdF (mass-average molecular weight: 280000), and acetylene black in a solid ratio so as to be 91:5:4% by mass, kneading the mixture using a planetary centrifugal mixer (manufactured by Thinky Corporation, “Rentaro”, 2000 rpm, 15 minutes), coating the slurried material on an aluminum foil having a thickness of 15 μm, temporarily drying at 80° C., and then drying under reduced pressure (160° C., 12 hours). The capacitance density on one side of NCM111 electrodes was 2.5 mAh/cm².

Graphite electrode, graphite, SBR, carboxy methylcellulose (CMC), acetylene black, VGCF was blended so as to be a 93.5:2.5:1.5:2:0.5% by mass in a solid ratio, kneaded using a planetary centrifugal mixer (manufactured by Thinky Corporation, “Rentaro”, 2000 rpm, 15 minutes), and slurried was coated on a copper foil having a thickness of 10 μm, temporarily dried at 80° C., and then dried under reduced pressure (160° C., 12 hours). The capacitance density on one side of the graphite electrodes was 3.0 mAh/cm². The graphite electrode in this test does not cancel the irreversible capacity.

TABLE 8

| | | COMPOSITION OF |
|---|---|---|
| | | SURFACE COAT |
| | | LAYER OF SEPARATOR |
| TEST BATTERY | TEST SEPARATOR | (SOLID MASS RATIO) |
| EXAMPLE 17 | TEST SEPARATOR 1 | BINDER 5 = 100 |
| EXAMPLE 18 | TEST SEPARATOR 2 | BINDER 5/Al2O3 = 60/40 |
| EXAMPLE 19 | TEST SEPARATOR 3 | BINDER 5/Al2O3 = 40/60 |
| EXAMPLE 20 | TEST SEPARATOR 4 | BINDER 5/Al2O3 = 20/80 |
| COMPARATIVE EXAMPLE 3 | TEST SEPARATOR 5 | UNCOATED |

### <Cycle Life Characteristics in 60° C. Environment>

This test is a test for evaluating the cycle life characteristics at 60° C. environment of the test battery of Examples 17-20 and Comparative Example 3.

In the charge/discharge test, charge/discharge was performed for 2 cycles with 0.1C-rate under the condition of environmental temperature of 60° C. and cut-off potential of 4.3-2.5V, followed by charge/discharge for 3 cycles with 0.2C-rate, followed by charge/discharge repeating with 1C-rate.

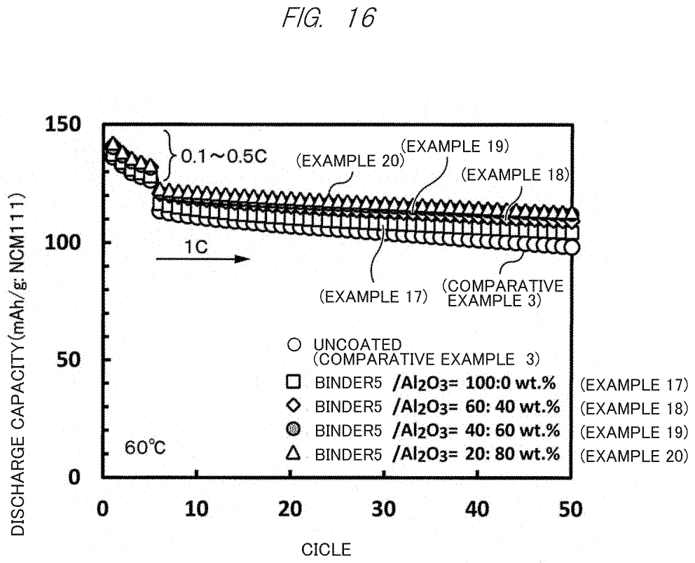

FIG. 16 is a graph comparing batteries with test separators 1 to 4 (Examples 17 to 20) and batteries with uncoated separators (Comparative Example 3).

As is apparent from FIG. 16, the cycle life characteristics are improved by providing a coating layer on the surface of the separator. In particular, the effect of including Al₂O₃ is significant.

### <Nailing Safety>

The safety of the battery using the surface-coated separator was tested in Example 21. As a comparison, a battery using an uncoated separator (Comparative Example 4) was produced and subjected to the same test.

The test method is based on a nailing test in which a nail is penetrated into a laminated battery to examine the state of smoking or ignition of the laminated battery. In the test, except a laminate battery having a 1.2 Ah in which a plurality of graphitic negative electrodes (capacity density of both sides is 6 mAh per cm²), separators, and NCM111 positive electrodes (capacity density of both sides is 5 mAh per cm²) are laminated on an aluminum laminate casing and an electrolyte solution is sealed was used, and Example 21 was the same as Example 20. Comparative Example 4 is the same as in Comparative Example 3.

The nailing test, after the battery was charged to 4.2V with a 0.1C-rate, an iron nail (φ3 mm, round type) was penetrated into the center of the battery at a speed of 1 mm/sec in a 25° C. environment, and the battery voltage, nail temperature, and the temperature of the casing were measured.

In the battery using an uncoated separator (Comparative Example 4), when performing nailing, the battery voltage is lowered to 0V, a large amount of smoke was generated. This is because the separator melted down due to heat generation when a short circuit occurred inside the battery, leading to a total short circuit.

On the other hand, the battery (Example 21) using a separator formed with a ceramic layer made of a binder 5 and a Al₂O₃ on the surface of the separator, even when nailing, a voltage of 3V or more was maintained, smoke was not generated, the temperature of the casing and nails was also maintained 50° C. or less, and the heat generation due to short circuit hardly occurred. This seems to be due to the fact that the separator did not melt down and did not lead to a total short circuit even if the heat generated when a short circuit occurred inside the battery.

### Embodiment 2

An electrode used in a LIB (lithium ion battery) is generally manufactured by coating a slurry in which an active material, a conductive auxiliary agent, and a binder are dispersed in a solvent such as an organic solvent or water on a current collector such as aluminum in a positive electrode and copper in a negative electrode, drying, and then rolling the slurry by a roll press. As the positive electrode active material, for example, lithium cobaltate (LiCoO₂), a ternary material (Li(Ni,Co,Mn)O₂:NCM), or the like is used, and a binder is used to adhere the active material to a conductive aid such as graphite and a conductor.

Polyvinylidene fluoride (PVdF), which is a typical positive electrode binder, swells by absorbing an electrolytic solution in a high temperature environment of 50° C. or higher, so that the binding force decrease and the electrode resistance are increased. If this positive electrode binder is replaced with water, swelling of the electrode is suppressed, but if a High-Ni ternary system containing a large amount of Ni, or a nickel-cobalt-lithium aluminate (Li(Ni,Co,Al)O₂:NCA) system, which is considered promising as a next-generation positive electrode material, is used as the positive electrode material, even a small amount of moisture reacts with Li in the active material, the slurry becomes alkaline, and PVdF binder is gelated. For this reason, manufacturing under strict temperature and humidity control is required, and therefore, it is required to develop a PVdF binder that can be handled under temperature and humidity control similar to that of conventional batteries.

Therefore, in this embodiment (Example), a cellulose nanofiber binder of dissolved carbon dioxide gas described in detail also in Embodiment 1 was studied.

### [8. Carbon Dioxide Dissolved Cellulose Nanofiber Binder]

A cellulose nanofiber binder in which carbon dioxide gas was dissolved was fabricated. A binder was placed in a sealed container, and a carbon dioxide gas was dissolved in the binder solvent by connecting a carbon dioxide cylinder to this. The pressure of the carbonated cylinder was 0.2 MPa, and the carbon dioxide was allowed to leave or stand for 10 minutes to dissolve in the binder.

The binder 26 is obtained by dissolving carbon dioxide gas in a mixture in which the binder material B is 25% by mass as a solid composition and the binder material G is 75% by mass.

The binder 27 is obtained by dissolving carbon dioxide gas only in the binder material G. In other words, the binder 27 does not contain cellulose nanofibers.

The binder 26 or the binder 27 was used to prepare an NCA positive electrode and a graphite negative electrode. The NCA positive electrode was produced as follows. NCA, AB, and binder were blended so as to have a solid ratio of 94:2:4% by mass, and kneaded using a planetary centrifugal mixer (manufactured by Thinky Corporation, “Rentaro”, 2000 rpm, 15 minutes) to prepare a slurry. This slurry was coated on an aluminum foil having a thickness of 20 μm using an applicator, temporarily dried at 80° C., then rolled by a roll press, and dried under reduced pressure (160° C. for 12 hours) to prepare an NCA positive electrode. The capacitive density of the respective NCA-positive electrode was 1.5 mAh/cm². The graphite negative electrode was produced as follows. Artificial graphite, AB, and binder were blended so as to have a solid ratio of 94:2:4% by mass, and kneaded using a planetary centrifugal mixer (manufactured by Thinky Corporation, “Rentaro”, 2000 rpm, 15 minutes) to prepare a slurry. This slurry was coated on a copper foil having a thickness of 10 μm using an applicator, temporarily dried at 80° C., and then rolled by a roll press, followed by vacuum drying at 160° C. for 12 hours to prepare a graphite negative electrode. The volume density of the graphitic negative electrode was 1.7 mAh/cm².

Batteries using NCA positive electrodes and graphite negative electrodes were produced (Examples 22 to 24, Comparative Example 5).

In Example 22, a battery in which the binder 26 was used for the NCA positive electrode and the binder 27 was used for the graphite negative electrode, was produced.

In Example 23, a battery in which the binder 27 was used for the NCA positive electrode and the binder 26 was used for the graphite negative electrode, was produced.

In Example 24, a battery in which the binder 26 was used for the NCA positive electrode and the graphite negative electrode, respectively, was produced.

In Comparative Example 5, a battery in which the binder 27 was used for the NCA positive electrode and the graphite negative electrode, respectively, was produced.

The test batteries (full batteries) produced in Examples 22 to 24 and Comparative Example 5 were RC2032 type coin cells in which a glass-nonwoven fabric (GA-100) was interposed between an NCA positive electrode and a graphite negative electrode, and 1 mol/L LiPF₆ (EC:DEC=50:50 vol.) was used as an electrolyte.

### <Cycle Life Characteristics in 60° C. Environment>

The test batteries of Examples 22-24 and Comparative Example 5 were tested for cycle life characteristics in a 60° C. environment.

In the charge/discharge test, charge/discharge was repeated 1000 times with 6C-rate after one cycle of charge/discharge at each rate of 0.2C-rate, o.5C-rate, 1C-rate, 3C-rate, 5C-rate, 10C-rate under the condition of environmental temperature of 60° C. and cut-off potential of 4.2-2.8V.

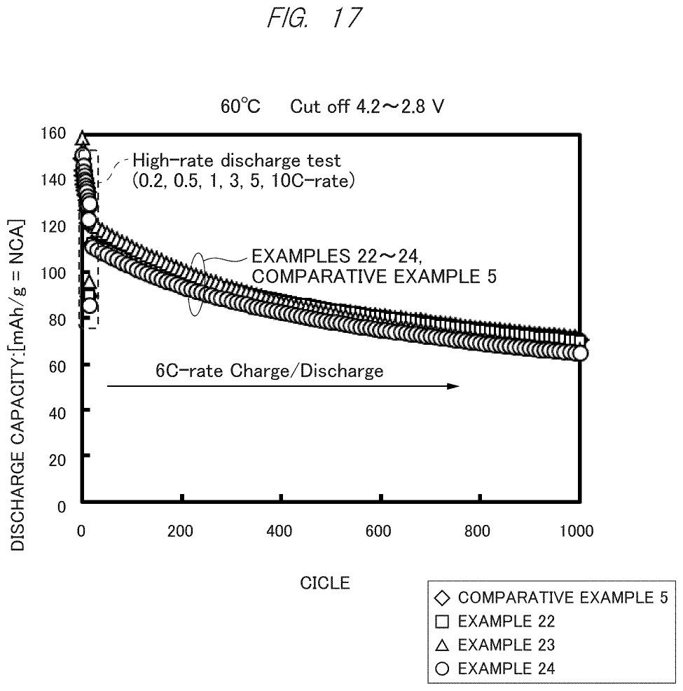

FIG. 17 is a graph showing cycle life characteristics of the test batteries of Examples 22-24 and Comparative Example 5 in a 60° C. environment.

In each of the test batteries, a large difference in battery characteristics in a 60° C. environment is not observed.

### <Cycle Life Characteristics in 80° C. Environment>

The test batteries of Examples 22-24 and Comparative Example 5 were tested for cycle life characteristics in an 80° C. environment.

In the charge/discharge test, charging and discharging were repeated 200 times with 3C-rate after charging and discharging at each rate of 0.2C-rate, 0.5C-rate, 1C-rate, 3C-rate, 5C-rate, 10C-rate for one cycle at ambient temperatures of 80° C. and cut-off potentials of 4.2 to 2.8V.

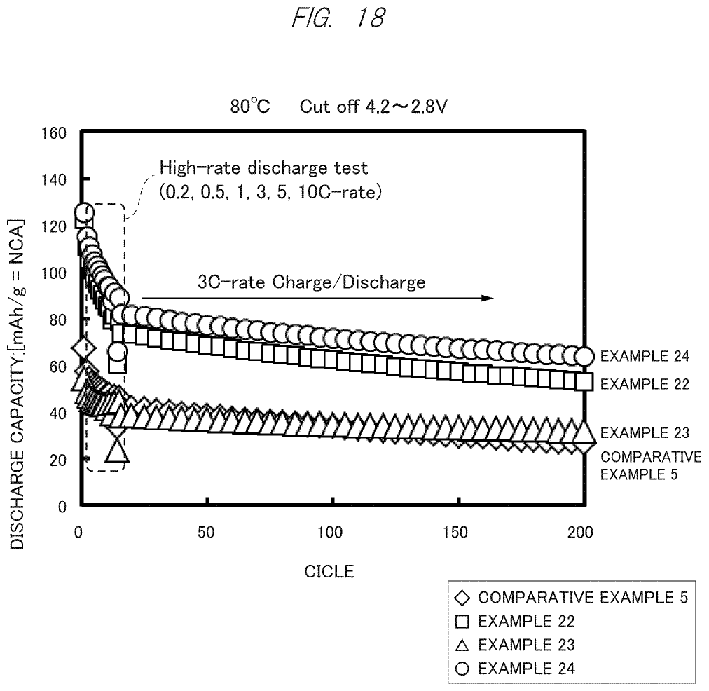

FIG. 18 is a graph showing cycle life characteristics of the test batteries of Examples 22-24 and Comparative Example 5 in an 80° C. environment.

The test battery of Example 22 exhibited superior cycle characteristics and high rate discharge characteristics compared to the test battery of Comparative Example 5.

The test battery of Example 23 exhibited slightly superior cycle characteristics compared to the test battery of Comparative Example 5.

The test battery of Example 24 exhibited superior cycle characteristics and high rate discharge characteristics compared to the test battery of Comparative Example 5.

From the above results, in a harsh environment at 80° C., the characteristics of the test battery using the binder 26 are good, by using the binder material B and the binder material G as a solid composition, and by using a binder 26 in which carbon dioxide gas is dissolved, it has been clarified that the battery characteristics are improved.

### <Observation of Electrode Cross Section>

The batteries (Example 22 and Example 23) after the charge/discharge test in the 60° C. environment and the 80° C. environment were disassembled, and the cross-sections of the positive electrode and the negative electrode were observed by SEM. Electrodes before charging and discharging were similarly disassembled and cross-sections of the positive and negative electrodes were observed by SEM.

FIG. 19 is an SEM image showing a cross section of the positive electrode of Example 22 before charging and discharging and after the charging and discharging test.

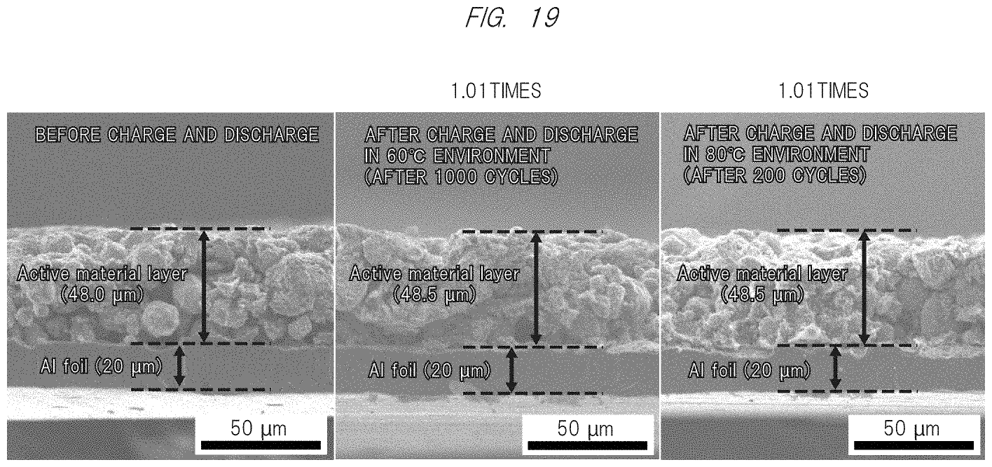

FIG. 20 is an SEM image showing a cross section of the positive electrode of Example 23 before charging and discharging and after the charging and discharging test.

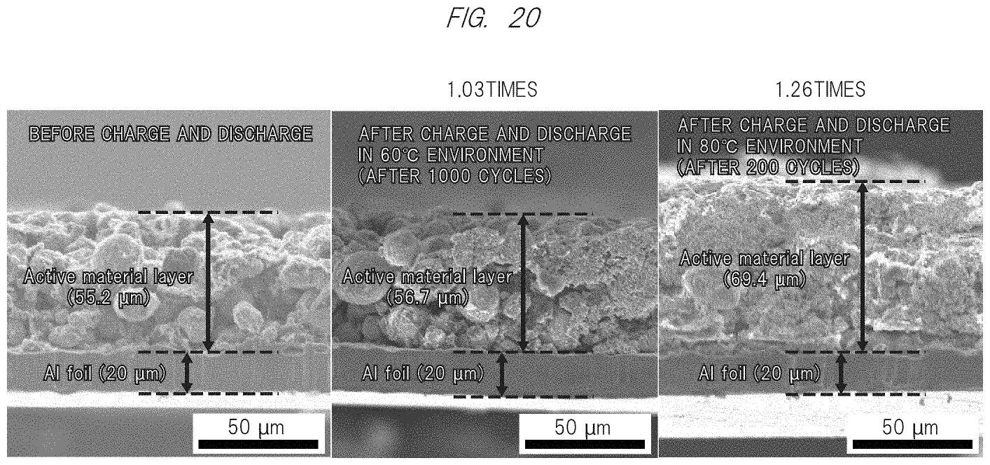

FIG. 21 is an SEM image showing a cross section of the negative electrode of Example 22 before charging and discharging and after the charging and discharging test.

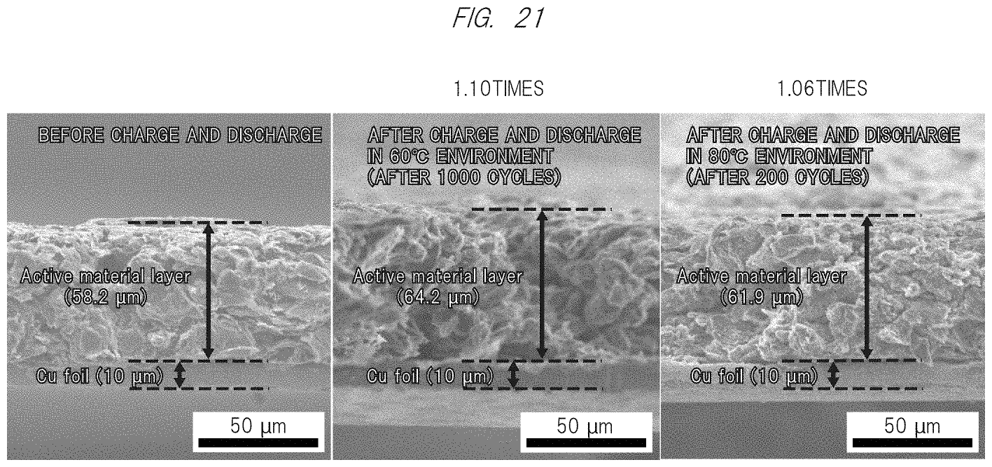

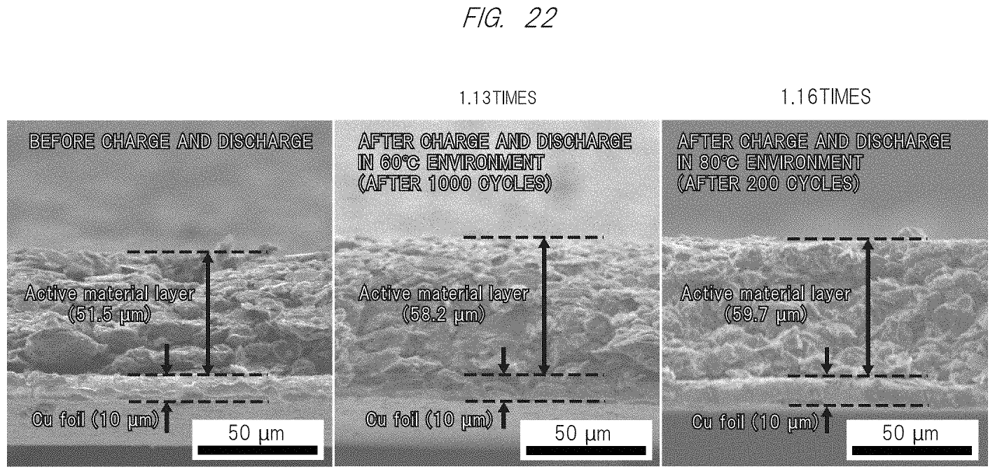

FIG. 22 is an SEM image showing a cross section of the negative electrode of Example 23 before charging and discharging and after the charging and discharging test.

The positive electrode active material layer of Example 22 showed a swelling of 1.01 times after the test in a 60° C. environment and 1.01 times after the test in an 80° C. environment as compared with the positive electrode before charging and discharging.

The positive electrode active material layer of Example 23 showed a swelling of 1.03 times after the test in a 60° C. environment and 1.26 times after the test in an 80° C. environment as compared with the positive electrode before charging and discharging.

The negative electrode active material layer of Example 22 exhibited 1.13 times swelling after testing in a 60° C. environment and 1.16 times swelling after testing in a 80° C. environment compared with a negative electrode before charging and discharging.

The negative electrode active material layer of Example 23 exhibited swelling of 1.10 times after testing in a 60° C. environment and swelling of 1.06 times after testing in a 80° C. environment compared with a negative electrode before charging and discharging.

In the negative electrode, an effect that an electrode using a binder 26 can suppress swelling of a slight active material layer as compared with an electrode using a binder 27 was confirmed, but a larger effect was not confirmed as much as a positive electrode described later. This is because the volume change of the negative electrode active material accompanying the charge and discharge is larger than that of the swelling of the binder, and means that the battery deterioration has a large influence due to the volume change of the negative electrode active material. Therefore, it is considered that even if the binder 26 is used for the negative electrode in a high temperature environment, a large effect on the cycle characteristics is not observed.

On the other hand, in the positive electrode, it was confirmed that the electrode using the binder 26 effectively suppressed swelling of the positive electrode active material layer as compared with the electrode using the binder 27. This is considered to be because the change in volume of the positive electrode active material due to charging and discharging is minute, and therefore, the electrode resistance due to the swelling of the binder greatly influences the battery characteristics.

Further, it was confirmed that the electrode using the binder 26 had less deposition of decomposed products of the electrolyte on the electrode than the electrode using the binder 27. The inclusion of cellulose nanofibers suggests the possibility of suppressing the decomposition of the electrolytic solution.

Therefore, it seems that the effect of using the binder 26 to the positive electrode in a high temperature environment was sufficiently exhibited.

### Embodiment 3

As a result of applying the developed SA-treated cellulose to each member of the LIB in the present embodiment, the respective characteristic values were improved. Therefore, a 2032 type next generation type LIB (Table 9) was manufactured by applying a prototype separator, a heat-resistant coating liquid, and a binder for positive electrode, and the battery characteristics were evaluated.

TABLE 9

| | | |
|---|---|---|
| \textcircled{1} | POSITIVE | NCA:AB:PVdF:SACeNF = 92:4:3:1 wt %/Al foil 20 μm |
| CONVENTIONAL | ELECTRODE | |
| LIB | NEGATIVE | Graphite:AB:PVdF = 91:4:wt %/Cu foil 10 μm |
| | ELECTRODE | |
| | CHAPTER | PE UNIT SEPARATOR |
| | COATING | UNCOATED |
| \textcircled{2} | POSITIVE | NCA:AB:PVdF:SACeNF = 92:4:3:1 wt %/Al foil 20 μm |
| ALUMINA | ELECTRODE | |
| COATED LIB | NEGATIVE | Graphite:AB:PVdF:SACeNF = 94:4:3:1 wt %/Cu foil 10 μm |
| | ELECTRODE | |
| | CHAPTER | CeNFCOMPOSITE SEPARATOR (CHAPTER 3 SAMPLE) |
| | COATING | ALUMINA COATING |
| \textcircled{3} | POSITIVE | NCA:AB:PVdF:SACeNF = 92:4:3:1 wt %/Al foil 20 μm |
| DEVELOPED | ELECTRODE | |
| LIB | NEGATIVE | Graphite:AB:PVdF:SACeNF = 94:4:3:1 wt %/Cu foil 10 μm |
| | ELECTRODE | |
| | CHAPTER | CeNF COMPOSITE SEPARATOR (CHAPTER 3 SAMPLE) |
| | COATING | ALUMINA CeNFCOATING COATED (CHAPTER 4 SAMPLE) |
| BATTERY | ELECTROLYTIC | 1.0 MLiPF₆/(EC:DEC = 50:50vol. % + VC1 wt %) |
| CONFIGURATION | SOLUTION | |
| | ELECTRODE | POSITIVE ELECTRODE:15 mAh/cm² |
| | CAPACITY | NEGATIVE ELECTRODE:1.7 mAh/cm² |

In order to evaluate the characteristics of the prototype LIB, a high temperature shelf or standing test and a charge/discharge cycle test were conducted. In this test, to verify the effectiveness of adding SA-treated CeNF to the respective LIB members, we fabricated an unsupplemented separator sample and compared the performance differences. In addition, when the binder of the positive electrode material was made of PVdF alone, it is expected that PVdF was expected to swell and the charge/discharge characteristics in a high temperature environment were expected to remarkably deteriorate, so in this evaluation, a binder for electrode to which CeNF was added was prepared and used for the evaluation. In the high temperature shelf or standing test, the three LIBs shown in Table 9, which were charged to 4.6V, were left for 1 hour at each temperature of 30-150° C. After the battery was cooled to room temperature, and was discharged with 0.1C, and the battery capacity was measured when the battery was cut off at 3V.

In the cycle characteristic evaluation test, the battery capacity was measured after heating each of the three types of LIB to 60° C. in the same manner as in the high temperature shelf test. The discharge rate was changed from 0.1 to 1C in the charge/discharge cycle up to 25 cycles, and the discharge rate after 26 cycles was measured with the discharge rate as high as 3C in order to clarify the performance differences of the respective samples. The charging and discharging were repeated for 120 cycles, and the battery capacity in each cycle was measured.

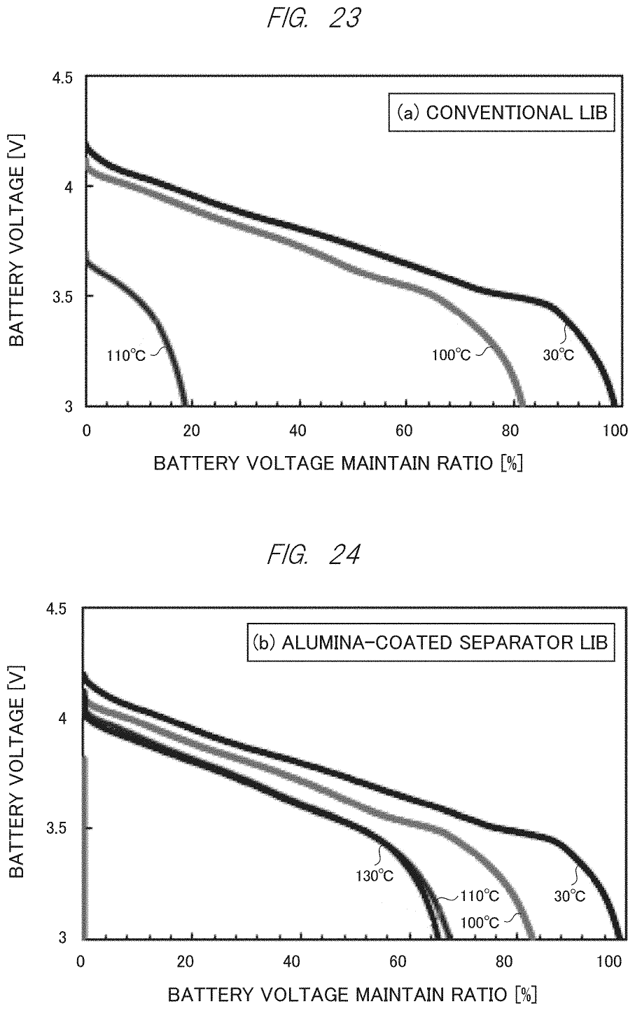

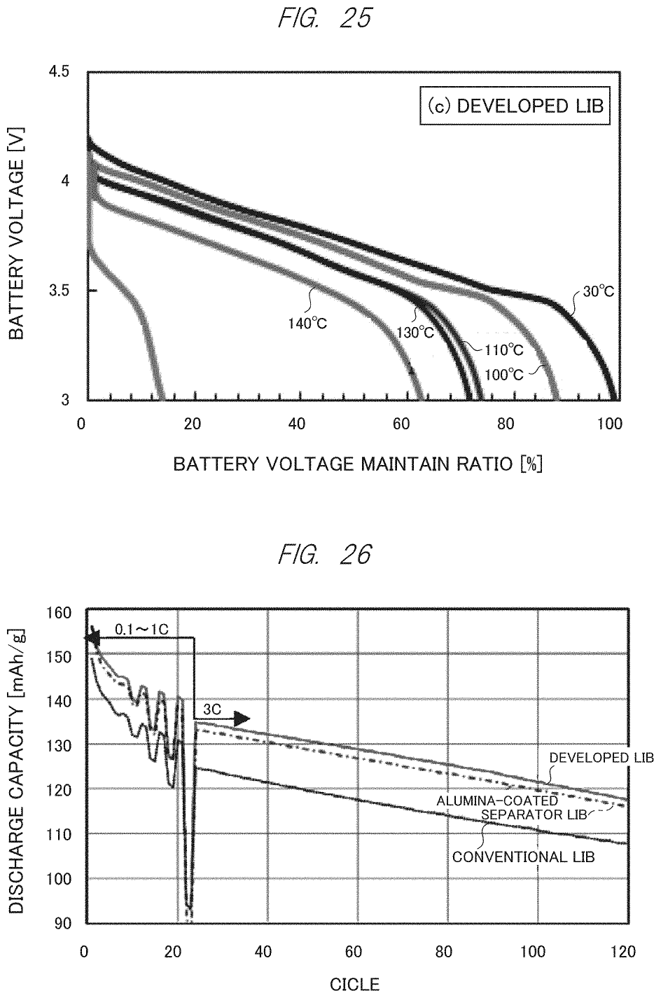

FIGS. 23 to 25 show the results of the high temperature shelf or standing test of each battery. The LIB ((a) conventional LIB) in which the SA-treated CeNF is not applied to the member has a battery capacity retention rate of about 20% at 110° C., and thus the battery cannot be completely charged and discharged at 120° C. Next, in the LIB coated with alumina (b) alumina-coated LIB) in which the SA-treated CeNF was added to the separator base material, the battery capacity of about 60% was maintained up to 130° C., but the battery capacity was completely short-circuited at 140° C. and the separator base material did not operate as a battery. On the other hand, in the case of LIB (developed LIB (c)) in which SA-treated CeNF was added to the separator base material and the heat-resistant coating solution, it was confirmed that the battery capacity of 70% was maintained even at 130° C., when the separator base material and the heat-resistant coating solution were not operated as a battery in the conventional case of LIB, and charge and discharge were possible up to 150° C.

In the high temperature shelf test, since the inside of the LIB is heated, the micropores of the separator are closed, and the amount of Li ions that move between the electrodes is reduced, so that the battery capacity is lowered. However, this time, it is presumed that the heat resistance of the base material itself is improved by compounding the separator base material and CeNF. In addition, it is considered that the use of the heat-resistant coating solution added with CeNF on the surfaces of the separators enhanced the ability of the coating layers to maintain their shapes by improving the binding properties of the coating layers, thereby suppressing the shrinkage of the base material and maintaining fine pores even in high temperature environments, and thus functioned as a battery.

In the cycle characteristics evaluating test, the discharge rate was evaluated as a 3C after charging and discharging at 0.1 to 1C for aging up to 30 cycles and after 30 cycles (FIG. 26). Compared with the conventional LIB, the developed LIB and the alumina-coated LIB have higher discharge capacity after 120 cycles. It is presumed that this is because the wettability of the electrolyte solution is improved and the internal resistance is reduced by applying the coating to the surface of the separator. The developed LIB has a higher discharge capacity than the alumina-coated LIB.

Since the separators mounted on the developed LIBs are coated with CeNF other than alumina and are compounded with resins, it is considered that the compatibility with the electrolytic solution is further improved and the inner resistivity is lowered. From the above, the developed LIB has improved high temperature durability and initial charge/discharge capacity compared with the conventional LIB, and from this fact, it has been clarified that the cycle characteristics are improved.

The invention made by the present inventors has been described above in detail based on the embodiments and examples, and the results made by the present inventors are summarized as follows.

(1) In order to greatly improve the defibration efficiency of the SA-treated cellulose, it is effective to enhance the hydrophobizing and to permeate the solvent into the cellulose.

(2) The separator was produced experimentally using the dispersion which defibrated cellulose than the conventional one. As a result, a separator having a penetration strength of 1.5 times higher than that in the event of not added was obtained.

(3) As a result of preparing an alumina coating liquid to which an SA-treated CeNF was added and coating it on a separator surface, a coating liquid capable of suppressing a heat shrinkage ratio up to 5% or less (more preferably, 3% or less) even at 200° C. was obtained.

(4) It was confirmed that the binder in which hydrophobized CeNF was complexed with PVdF functions as a battery even in 80° C. environment which is impossible to operate due to swelling of electrolytic solution until now.

(5) The developed high-heat-resistant binder did not be gelated and had fluidity even when the positive electrode was manufactured under an atmospheric environment in which temperature and humidity were not strictly controlled.

(6) It was confirmed that the performance such as heat resistance and cyclic property was greatly improved in the battery in which the SA-treated CeNF was applied to every member of LIB in comparison with the conventional LIB.

While the invention made by the present inventor has been specifically described based on the embodiments and examples, the present invention is not limited to the above-described embodiments or examples, and it is needless to say that various modifications can be made without departing from the gist thereof. For example, the ratio of the cellulose nanofiber and the thermoplastic fluorine-based resin is not limited to the numerical values of the above examples. Further, PVdF is not limited to those of the above examples, and may be a polymer or a copolymer, and the mass-average molecular weight is not limited to 280000. Further, the cellulose nanofiber may contain an anionic group such as a carboxylic acid group, a sulfonic acid group, a phosphoric acid group, or a sulfate group.

Further, the active material is not limited to NCA or NCM523, and any material capable of reversibly storing and releasing an alkali-metal element (e.g., Li) may be used.

### Appendix 1

An electrode for a nonaqueous electrolyte secondary battery having an active material and a binder for electrode,

the active material, at least, has an alkali metal element as a constituent element,

the binder for electrode has a cellulose and a solvent,

carbon dioxide is dissolved in the solvent,

a part or all of the surface of the active material is coated with the cellulose, and

an electrode for a nonaqueous electrolyte secondary battery, wherein a carbonic acid compound of the alkali metal element is coated on a part or all of a surface of the cellulose.

### Appendix 2

A method of manufacturing an electrode for a nonaqueous electrolyte secondary battery, comprising

(a1) a step of forming a binder for electrode having cellulose and a solvent and having carbon dioxide gas dissolved therein,

(a2) a step of forming a slurry having an electrode active material and a binder for electrode,

(a3) a step of forming an electrode by applying the slurry to a current collector,

wherein,

the electrode active material, at least, has an alkali metal element as a constituent element,

a part or all of the surface of the electrode active material is coated with the cellulose, and

a carbonic acid compound of the alkali metal element is coated on a part or all of a surface of the cellulose.

### Appendix 3

An electrode binder for nonaqueous electrolyte secondary battery, having cellulose and a solvent, wherein carbon dioxide gas is dissolved in a binder solvent containing the cellulose and the solvent at a concentration of 50 mg/L or more and 9000 mg/L or less.

### Appendix 4

The electrode binder for nonaqueous electrolyte secondary battery according to Appendix 3,

the cellulose covers a part or all of the surface of the electrode active material,

a carbonate compound of an alkali metal element which is a constituent element of the electrode active material is coated on a part or all of a surface of the cellulose.

### Appendix 5

The electrode binder for nonaqueous electrolyte secondary battery according to Appendix 3, wherein

an electrode binder for nonaqueous electrolyte secondary battery having a thermoplastic resin.

### Appendix 6

The electrode binder for a nonaqueous electrolyte secondary battery according to Appendix 5, wherein

an electrode binder for a nonaqueous electrolyte secondary battery, wherein the thermoplastic resin absorbs an electrolytic solution to produce a polymer gel.

### Appendix 7

The electrode binder for a nonaqueous electrolyte secondary battery according to Appendix 5, wherein

the cellulose is 5% by mass or more and 80% by mass or less, and the thermoplastic resin is 20% by mass or more and 95% by mass or less.

### Appendix 8

The electrode binder for a nonaqueous electrolyte secondary battery according to Appendix 3, wherein

the cellulose has a fiber diameter of 0.002 μm or more and 1 μm or less, a fiber length of 0.5 μm or more and 10 mm or less, and an aspect ratio (fiber length/fiber diameter) of 2 or more and 100000 or less.

### Appendix 9

The electrode binder for a nonaqueous electrolyte secondary battery according to Appendix 8, wherein

the cellulose comprises cellulose in which a hydrophilic group of cellulose is substituted with a hydrophobic group by reaction of cellulose and an additive.

### Appendix 10

The electrode binder for a nonaqueous electrolyte secondary battery according to Appendix 9, wherein

the cellulose comprises cellulose hydrophobized by a part of a hydroxyl group being replaced with a carboxyl group.

### Appendix 11

The electrode binder for a nonaqueous electrolyte secondary battery according to Appendix 10, wherein

the cellulose comprises cellulose subjected to ethylene oxide addition treatment or propylene oxide addition treatment.

### Appendix 12

The electrode binder for a nonaqueous electrolyte secondary battery according to Appendix 3, wherein

the solvent is N-methylpyrrolidone.

### Appendix 13

A method for manufacturing an electrode binder for a nonaqueous electrolyte secondary battery, the electrode binder having cellulose and a solvent, wherein

the carbon dioxide gas is dissolved in a binder solvent containing the cellulose and the solvent at a concentration of 50 mg/L or more and 9000 mg/L or less.

What is claimed is:

1. A nonaqueous electrolyte secondary battery having a positive electrode, a negative electrode, a separator disposed between the positive electrode and the negative electrode, and an electrolytic solution, wherein
the positive electrode includes a positive electrode active material and a binder for positive electrode,
the positive electrode active material, at least, has an alkali metal element as a constituent element,
the binder for positive electrode has a cellulose, and a solvent,
carbon dioxide is dissolved in the solvent,
a part or all of the surface of the positive electrode active material is coated with the cellulose, and
a carbonic acid compound of alkali metal element is coated on a part or all of a surface of the cellulose.

2. The nonaqueous electrolyte secondary battery according to claim 1, wherein
the binder for positive electrodes further has a thermoplastic resin.

3. The nonaqueous electrolyte secondary battery according to claim 2, wherein
the thermoplastic resin has a polymer gel absorbed the electrolytic solution.

4. The nonaqueous electrolyte secondary battery according to claim 3, wherein
in the binder for positive electrode, cellulose is 5% by mass or more and 80% by mass or less, and the thermoplastic resin is 20% by mass or more and 95% by mass or less.

5. The nonaqueous electrolyte secondary battery according to claim 1, wherein
the carbon dioxide gas is dissolved in a binder solvent containing the cellulose and the solvent at a concentration of 50 mg/L or more and 9000 mg/L or less.

6. The nonaqueous electrolyte secondary battery according to claim 1, wherein
the cellulose has a fiber diameter of 0.002 μm or more and 1 μm or less, a fiber length of 0.5 μm or more and 10 mm or less, and an aspect ratio of fiber length/fiber diameter of 2 or more and 100000 or less.

7. The nonaqueous electrolyte secondary battery according to claim 5, wherein
the cellulose includes cellulose in which a hydrophilic group of cellulose is substituted with a hydrophobic group by reaction of cellulose and an additive.

8. The nonaqueous electrolyte secondary battery according to claim 7, wherein
the cellulose comprises cellulose hydrophobized by a part of a hydroxyl group being replaced with a carboxyl group.

9. The nonaqueous electrolyte secondary battery according to claim 8, wherein
the cellulose comprises cellulose subjected to ethylene oxide addition treatment or propylene oxide addition treatment.

10. The nonaqueous electrolyte secondary battery according to claim 6, wherein
the cellulose is subjected to a defibration treatment, and
the defibration treatment is a chemical treatment or a physical treatment.

11. The nonaqueous electrolyte secondary battery according to claim 10, wherein
the chemical treatment is performed by adding one or more kinds of reagents having a pH value of 0.1 or more and 13 or less and a melting point of −20° C. to 200° C.

12. The nonaqueous electrolyte secondary battery according to claim 10, wherein
the physical treatment is performed using a grinder, a bead mill, an opposed collision treatment device, a high pressure homogenizer or a water jet.

13. The nonaqueous electrolyte secondary battery according to claim 1, wherein
the solvent is N-methylpyrrolidone.

14. A method of manufacturing a nonaqueous electrolyte secondary battery, comprising
(a) a step of preparing a positive electrode, a negative electrode, a separator disposed between the positive electrode and the negative electrode, and an electrolyte;
(b) a step of laminating the positive electrode, the negative electrode, and the separator and immersing them in an electrolytic solution, and
(c) a step of preparing the positive electrode,
the step (c) includes
(c1) a step of forming a binder for positive electrode having cellulose and a solvent and having carbon dioxide gas dissolved therein,
(c2) a step of forming a slurry having a positive electrode active material and the binder for positive electrode,
(c3) a step of forming the positive electrode by applying the slurry to a current collector,
the positive electrode active material, at least, has an alkali metal element as a constituent element,
in the step (b),
a part or all of the surface of the positive electrode active material is coated with the cellulose, and
a carbonic acid compound of the alkali metal element is coated on a part or all of a surface of the cellulose.

15. The method of manufacturing a nonaqueous electrolyte secondary battery according to claim 14, wherein
the binder for positive electrodes further has thermoplastic resin.

16. The method of manufacturing a nonaqueous electrolyte secondary battery according to claim 15, wherein
in the step (b),
a polymer gel in which the thermoplastic resin absorbs the electrolytic solution is formed.

17. The method of manufacturing a nonaqueous electrolyte secondary battery according to claim 15, wherein
in the binder for positive electrode, cellulose is 5% by mass or more and 80% by mass or less, and the thermoplastic resin is 20% by mass or more and 95% by mass or less.

18. The method of manufacturing a nonaqueous electrolyte secondary battery according to claim 14, wherein
the carbon dioxide gas is dissolved in a binder solvent containing the cellulose and the solvent at a concentration of 50 mg/L or more and 9000 mg/L or less.

19. The method of manufacturing a nonaqueous electrolyte secondary battery according to claim 14, wherein
the cellulose has a fiber diameter of 0.002 μm or more and 1 μm or less, a fiber length of 0.5 μm or more and 10 mm or less, and an aspect ratio of fiber length/fiber diameter of 2 or more and 100000 or less.

20. The method of manufacturing a nonaqueous electrolyte secondary battery according to claim 14, wherein
a hydrophilic group of cellulose comprises cellulose substituted with a hydrophobic group.

21. The method of manufacturing a nonaqueous electrolyte secondary battery according to claim 20, wherein
the cellulose comprises cellulose hydrophobized by a part of a hydroxyl group being replaced with a carboxyl group.

22. The method of manufacturing a nonaqueous electrolyte secondary battery according to claim 21, wherein
the cellulose comprises cellulose subjected to an ethylene oxide addition treatment or a propylene oxide addition treatment.

23. The method of manufacturing a nonaqueous electrolyte secondary battery according to claim 19, wherein
the cellulose is subjected to a defibration treatment, and
the defibration treatment is a chemical treatment or a physical treatment.

24. The method of manufacturing a nonaqueous electrolyte secondary battery according to claim 23, wherein
the chemical treatment is performed by adding one or more kinds of reagents having pH value of 0.1 or more and 13 or less, and having melting point of −20° C. to 200° C.

25. The method of manufacturing a nonaqueous electrolyte secondary battery according to claim 23, wherein
the physical treatment is performed using a grinder, a bead mill, an opposed collision treatment apparatus, a high pressure homogenizer or a water jet.

26. The method of manufacturing a nonaqueous electrolyte secondary battery according to claim 14, wherein
the solvent is a N-methylpyrrolidone.

27. The method of manufacturing a nonaqueous electrolyte secondary battery according to claim 19, wherein
in the step (c1) comprising
a step of obtaining a mixed solvent liquid comprising the cellulose and a liquid medium and the N-methyl-2-pyrrolidone, and
a step of evaporating the liquid medium in the mixed solvent liquid to increase the concentration of N-methyl-2-pyrrolidone.
